(19) United States
(12) Patent Application Publication
(10) Pub. No.: US 2026/0331525 A1
(43) Pub. Date: Oct. 22, 2026

(54) SOLID ION CONDUCTOR, METHOD OF MANUFACTURING THE SAME, AND SOLID OXIDE CELL INCLUDING THE SAME

(71) Applicant: Samsung Electronics Co., Ltd., Suwon-si (KR)

(72) Inventors: Jusik Kim, Suwon-si (KR); Seungbok Lee, Suwon-si (KR); Doh Won Jung, Suwon-si (KR)

(21) Appl. No.: 19/635,128

(22) Filed: Mar. 31, 2026

(30) Foreign Application Priority Data
Apr. 22, 2025 (KR) 10-2025-0052623

(51) Int. Cl. H01M 4/90; H01M 4/88; H01M 8/12; H01M 8/1213

(52) U.S. Cl. CPC H01M 4/9033; H01M 4/8882; H01M 8/1213; H01M 2008/1293

(57) ABSTRACT

A solid ion conductor, a method of manufacturing the solid ion conductor, and a solid oxide cell in which at least one of an air electrode, a fuel electrode, or a solid electrolyte layer includes the solid ion conductor. The solid ion conductor includes a metal oxide having a perovskite structure, the metal oxide includes: four or more elements arranged in a cubooctahedral site of the perovskite structure, where the four or more different elements include i) barium, strontium, and M¹ and M² elements or ii) barium, strontium, and M¹, M² and M³ elements; and
cobalt and iron, or ii) cobalt, iron, and M⁴, arranged in the octahedral site of the perovskite structure,
M¹, M², M³, and M⁴, and molar content of elements barium, strontium, M¹, M², M³, and M⁴ areas defined, and a molar content of cobalt is equal to or greater than a molar content of iron.

### CROSS-REFERENCE TO RELATED APPLICATION

This application claims priority to Korean Patent Application No. 10-2025-0052623, filed on Apr. 22, 2025, in the Korean Intellectual Property Office, and all the benefits accruing therefrom under 35 U.S.C. § 119, the disclosure of which in its entirety is incorporated by reference herein.

### BACKGROUND

### 1. Field

The disclosure relates to a solid ion conductor, a method of manufacturing the solid ion conductor, and a solid oxide cell including the solid ion conductor.

### 2. Description of the Related Art

Solid oxide cells may operate in a fuel cell mode where electricity is generated by oxidizing fuel and reducing air. For example, solid oxide cells may operate in an electrolytic cell mode where hydrogen is generated by the electrolysis of water. However, when a solid oxide cell operates in an electrolytic cell mode an air electrode of the solid oxide cell may deteriorate over time from high oxygen partial pressure that is generated in a local region of the air electrode. As a result, pores are likely to form in the air electrode and/or changes in stoichiometry of the air electrode may occur. The formation of pores in the air electrode and/or the changes in stoichiometry of the air electrode may decrease active reaction sites, thereby increasing an overpotential in the solid oxide cell. Moreover, an increase in overvoltage may further increase a local oxygen partial pressure in the air electrode, and result in delamination between the air electrode and a solid electrolyte layer.

In addition, when a solid oxide cell operates in an electrolytic mode, a metal on the surface of an air electrode is vaporized, and the vaporized metal diffuses into a solid electrolyte layer and forms an insulating phase between the air electrode and the solid electrolyte layer.

In solid oxide cells, improvements and further development solid ion conductor is needed, in particular, solid oxide cells that have improved structural stability that can suppress the deterioration of the air electrode by suppressing the delamination between the air electrode and the solid electrolyte layer and/or suppressing the formation of an insulating phase between the air electrode and the solid electrolyte layer.

### SUMMARY

Provided are a novel solid ion conductor having improved structural stability and a method of manufacturing the solid ion conductor.

Provided is an electrode including the solid ion conductor.

Provided is a metal oxide cell having improved durability by including the solid ion conductor.

Additional aspects will be set forth in part in the description which follows and, in part, will be apparent from the description, or may be learned by practice of the presented embodiments of the disclosure.

According to an aspect of the disclosure,
a solid ion conductor includes a metal oxide having a perovskite structure,
wherein the metal oxide may include four or more different elements arranged in a cubooctahedral site of the perovskite structure, the four or more different elements including i) barium (Ba), strontium (Sr), and M¹ and M² elements or ii) barium (Ba), strontium (Sr), and M¹, M² and M³ elements; and
   i) cobalt (Co) and iron (Fe), or ii) cobalt (Co), iron (Fe), and M⁴, arranged in an octahedral site of the perovskite structure,
wherein M¹ and M² may each independently be a cation having an oxidation number of 3+, a lanthanide element, a group 3 element, a group 5 element, a group 8 element, a group 10 element, or a combination thereof,
M³ may be a cation having an oxidation number 2+ or 3+, a group 2 element, a group 5 element, or a combination thereof, and
M⁴ may be a transition metal having an oxidation number 2+ or 3+, a group 4 element, a group 7 element, a group 10 to 13 element, a group 16 element, or a combination thereof,
molar content of Ba, Sr, and M¹ and M² elements may each be 0.5 or less with respect to a total moles of Ba, Sr, and M¹ and M² elements, or molar content of Ba, Sr, and M¹, M² and M³ elements may each be 0.5 or less with respect to a total moles of Ba, Sr, and M¹, M² and M³ elements, and
a molar content of Co may be greater than a molar content of Fe.

According to another aspect of the disclosure, the metal oxide having a perovskite structure is represented by Formula 1:

(BaₐSr_{b}M¹_{c}M²_{d}M³ₑ)(Co_{f}Fe_{g}M⁴ₕ)O_{3-δ} Formula 1
wherein M¹, M², M³, and M⁴ elements are as described above, and
0.1≤a≤0.4, 0.1≤b≤0.4, 0.1≤c≤0.5, 0.1≤d≤0.4, 0≤e≤0.4, f>0, g>0, f>g, 0≤h<0.2, 0≤δ<1, 0.9≤(a+b+c+d+e)≤1, and 0.9≤(f+g+h)≤1.

According to another aspect of the disclosure, an electrode includes the solid ion conductor.

The electrode may be an air electrode.

According to another aspect of the disclosure, a solid oxide cell includes
an air electrode, a fuel electrode, and a solid electrolyte layer between the air electrode and the fuel electrode,
wherein at least one of the air electrode, the fuel electrode, and the solid electrolyte layer may include the solid ion conductor described herein.

According to another aspect of the disclosure, a method of manufacturing a solid ion conductor includes mixing a barium precursor, a strontium precursor, an M¹ precursor, an M² precursor, a cobalt precursor, and an iron precursor, and optionally, an M3 precursor and/or an M4 precursor, to prepare a precursor mixture, and
heat-treating the precursor mixture to manufacture a solid ion conductor,
wherein the solid ion conductor may include a metal oxide having a perovskite structure as described above.

### BRIEF DESCRIPTION OF THE DRAWINGS

The above and other aspects, features, and advantages of certain embodiments of the disclosure will be more apparent from the following description taken in conjunction with the accompanying drawings, in which:

FIGS. 1A to 1D are X-ray diffraction (XRD) spectra of solid ion conductors manufactured in Examples 1, 2, 3, and 4, respectively;

FIGS. 2A and 2B are Nyquist plots showing the impedance measurement results of a solid oxide cell manufactured in Example 1 before and after applying constant current, respectively;

FIGS. 2C and 2D are Nyquist plots showing the impedance measurement results of to a solid oxide cell manufactured in Example 2 before and after applying constant current, respectively;

FIG. 2E is a Nyquist plot showing the impedance measurement results of a solid oxide cell manufactured in Example 5 before applying constant current;

FIGS. 2F and 2G are Nyquist plots showing the impedance measurement results of a solid oxide cell manufactured in Comparative Example 3 before and after applying constant current, respectively;

FIGS. 2H and 2I are Nyquist plots showing the impedance measurement results of a solid oxide cell manufactured in Reference Example 1 before and after applying constant current, respectively;

FIG. 3A is a plot showing a voltage change while applying a constant current to a solid oxide cell manufactured in Example 1;

FIG. 3B is a plot showing a voltage change while applying a constant current to a solid oxide cell manufactured in Example 2;

FIG. 3C is a plot showing a voltage change while applying a constant current to a solid oxide cell manufactured in Example 3;

FIG. 3D is a plot showing a voltage change while applying a constant current to a solid oxide cell manufactured in Example 5;

FIG. 3E is a plot showing a voltage change while applying a constant current to a solid oxide cell manufactured in Comparative Example 3;

FIG. 3F is a plot showing a voltage change while applying a constant current to a solid oxide cell manufactured in Reference Example 1;

FIG. 4 is a schematic cross-sectional view of an electrode according to an embodiment;

FIG. 5 is a schematic cross-sectional view of a solid oxide cell according to an embodiment;

FIG. 6 is a schematic cross-sectional view of a solid oxide cell according to an embodiment; and

FIG. 7 is an exploded perspective view of a solid oxide cell stack according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects.

Various embodiments are illustrated in the attached drawings. However, the present inventive concept may be embodied in many different forms and should not be construed as limited to the embodiments described herein. Rather, these embodiments are provided so that the disclosure will be made thoroughly and completely, and will fully transfer the scope of the present inventive concept to those skilled in the art. Identical reference numerals indicate identical components.

When a component is referred to as being “over” or “on” another component, it may be understood that the component may be directly on the another component, or that there may be other components intervening between the two components. In contrast, when a component is referred to as being “directly on” another component, there is no intervening component therebetween.

The terms “first,” “second,” “third,” etc. may be used herein to describe various components, ingredients, regions, layers and/or zones, but these components, ingredients, regions, layers and/or zones should not be limited by these terms. These terms are used only to distinguish one component, ingredient, region, layer or zone from another component, ingredient, region, layer or zone. Accordingly, a first component, ingredient, region, layer or zone described below may be referred to as a second component, ingredient, region, layer or zone without departing from the teachings of the present specification.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. Therefore, reference to “an” element in a claim followed by reference to “the” element is inclusive of one element as well as a plurality of the elements.

As used herein, the singular form is intended to include the plural form including “at least one,” unless the context clearly dictates otherwise. “At least one” should not be construed as limiting to the singular. As used herein, the term “and/or” includes any and all combinations of one or more of the listed items. The terms “includes” and/or “including” as used in the detailed description specify stated features, regions, integers, steps, operations, components and/or ingredients, but do not preclude the presence or addition of one or more other features, regions, integers, steps, operations, components, ingredients and/or groups thereof.

Unless otherwise defined, all terms (including technical and scientific terms) used herein have the same meaning as commonly understood by those skilled in the art to which this disclosure belongs. It will also be understood that terms defined in commonly used dictionaries should be interpreted to have a meaning consistent with their meaning within the context of the relevant art and the disclosure, and not in an idealized or overly formal sense.

Exemplary embodiments are described herein with reference to cross-sectional views which are schematic views of idealized embodiments. Likewise, variations in illustrated shapes must be expected as a result of manufacturing techniques and/or tolerances. Therefore, the embodiments described herein should not be construed as limited to the specific shapes of regions as illustrated herein, but should include deviations in shapes resulting from, for example, manufacturing. For example, a region illustrated or described as flat may typically have rough and/or non-linear features. Moreover, sharply illustrated angles may be round. Accordingly, the regions illustrated in the drawings are schematic in nature, and their shapes are not intended to illustrate the precise shape of the regions and are not intended to limit the scope of the present claims.

“Group” refers to a group in the periodic table of the elements according to the International Union of Pure and Applied Chemistry (“IUPAC”) Group 1 to 18 classification system.

As used herein, the “particle diameter” refers to an average diameter when particles are spherical, and refers to an average major axis length when the particles are non-spherical. The particle diameter may be measured using a particle size analyzer (PSA). The “particle diameter” refers to an average particle diameter. The “average particle diameter” refers to, for example, a median particle diameter (D50).

As used herein, the “solid ion conductor” refers to a solid material having ion conductivity for oxygen ions (O²⁻) or protons (H⁺).

As used herein, the “metal” includes both metals and metalloids such as silicon and germanium, in an elemental or ionic state.

As used herein, the “fuel electrode” refers to an electrode that receives a fluid containing a fuel such as hydrogen in a fuel cell mode of a solid oxide cell.

The “fuel electrode” also refers to an electrode that receives a fluid containing fuel such as water or carbon dioxide in an electrolytic cell mode of a solid oxide cell.

As used herein, the “air electrode” or “oxygen electrode” refers to an electrode that receives a fluid containing oxygen in a fuel cell mode of a solid oxide cell. The fluid containing oxygen is, for example, air.

The “air electrode” or “oxygen electrode” also refers to an electrode that discharges a fluid containing oxygen in an electrolytic cell mode of a solid oxide cell.

As used herein, the “positive electrode” or “cathode” refers to an electrode where reduction of oxygen occurs in a fuel cell mode of a solid oxide cell.

The “positive electrode” or “cathode” also refers to an electrode where reduction of fuel occurs in an electrolytic cell mode of a solid oxide cell.

As used herein, the “negative electrode” or “anode” refers to an electrode where oxidation of fuel occurs in a fuel cell mode of a solid oxide cell.

The “negative electrode” or “anode” also refers to an electrode where oxidation of oxygen ions or the like occurs in an electrolytic cell mode of a solid oxide cell.

Although specific embodiments have been described, alternatives, modifications, variations, improvements, and substantial equivalents which are not currently anticipated or cannot be anticipated may occur to the applicant or those skilled in the art. Accordingly, the appended claims, as filed and as amended, are intended to include all such alternatives, modifications, variations, improvements and substantial equivalents.

Hereinafter, a solid ion conductor according to an embodiment, an electrode including the solid ion conductor, and a solid oxide cell including the electrode will be described in more detail.

As an air electrode material for solid oxide cells, La—Sr—Co—Fe (LSCF), a perovskite material, doped with an additional element has been proposed. However, in many instances, such an air electrode material may undergo a phase change, and cause a segregation phenomenon due to the vaporization of surface strontium or a delamination phenomenon between an air electrode and a reaction barrier layer and/or between an air electrode and a solid electrolyte layer. Therefore, improvement and further development of a solid ion conductor or an air electrode material for solid oxide cells is needed.

In order to solve the above-described problems, a solid ion conductor, an electrode including the solid ion conductor, and a solid oxide cell including the electrode are provided according to an embodiment.

### [Solid Ion Conductor]

A solid ion conductor according to an embodiment includes a metal oxide having a perovskite structure, wherein the metal oxide includes four or more different elements arranged in a cubooctahedral site of the perovskite structure, the four or more different elements including i) barium (Ba), strontium (Sr), and M¹ and M² elements or ii) barium (Ba), strontium (Sr), and M¹, M², and M³ elements; and
cobalt (Co) and iron (Fe), or ii) cobalt (Co), iron (Fe), and M⁴, arranged in the octahedral site of the perovskite structure,
M¹ and M² are each independently a cation having an oxidation number of 3+, a lanthanide element, a group 3 element, a group 5 element, a group 8 element, a group 10 element, or a combination thereof,
M³ is a cation having an oxidation number 2+ or 3+, a group 2 element, a group 5 element, or a combination thereof,
M⁴ is a transition metal having an oxidation number 2+ or 3+, a group 4 element, a group 7 element, a group 10 to 13 element, a group 16 element, or a combination thereof,
the molar content of Ba, Sr, and M¹ and M² elements are each 0.5 or less with respect to the total moles of Ba, Sr, and M¹ and M² elements; or the molar content of Ba, Sr, and M¹, M² and M³ elements are each 0.5 or less with respect to the total moles of Ba, Sr, and M¹, M² and M³ elements, and the molar content of Co is greater than the molar content of Fe.

The molar content of Ba, Sr, and M¹, M², or M³ element is, for example, a ratio of the mole number of each of Ba, Sr, and M¹, M² and M³ elements to the total mole number of Ba, Sr, and M¹, M² and M³ elements in the metal oxide compound. The molar content is also referred to in the art as a “mole fraction” of each element in the compound where the sum of all the mole fractions is essentially one.

The molar content of Ba, Sr, and M¹, M² and M³ elements may each independently be about 0.01 to about 0.5, about 0.05 to about 0.5, about 0.05 to about 0.45, about 0.05 to about 0.4, about 0.05 to about 0.35, or about 0.05 to about 0.3, respectively, with respect to the total moles of Ba, Sr, and M¹, M² and M³ elements.

The metal oxide includes a compound represented by Formula 1 below:

(BaₐSr_{b}M¹_{c}M²_{d}M³ₑ)(Co_{f}Fe_{g}M⁴ₕ)O_{3-δ} Formula 1
wherein, in Formula 1,
M¹ and M² may each be independently a cation having an oxidation number of 3+, a lanthanide element, a group 3 element, a group 5 element, a group 8 element, a group 10 element, or a combination thereof,
M³ may be a cation having an oxidation number 2+ or 3+, a group 2 element, a group 5 element, or a combination thereof,
M⁴ may be a transition metal having an oxidation number 2+ or 3+, a group 4 element, a group 7 element, a group 10 to 13 element, a group 16 element, or a combination thereof, and
0.1≤a≤0.4, 0.1≤b≤0.4, 0.1≤c≤0.5, 0.1≤d≤0.4, 0≤e≤0.4, f>0, g>0, f>g, 0≤h<0.2, 0≤δ<1, 0.9≤(a+b+c+d+e)≤1, and 0.9≤(f+g+h)≤1.

In Formula 1, a to e each represent a ratio of the mole number (or mole fraction) of each element to the total mole number of Ba, Sr, M¹, M², and M³. Also, f, g and h each represent a ratio of the mole number of each element to the total mole number of Co, Fe, and M⁴.

In Formula 1, 0 represents an oxygen defect, and 0≤δ<1, 0<0≤0.8, 0<0≤0.6, or 0<δ≤0.5.

The solid ion conductor of Formula 1 has excellent structural stability, and the phase stability of the solid ion conductor may be further improved by including M¹ and M² in Formula 1.

M¹ and M² may each be independently a lanthanide element, for example, La, Ce, Pr, Nd, Pm, Sm, Eu, Gd, Tb, Dy, Ho, Er, Ym, Yb, Lu, or a combination thereof. The lanthanide element may include, in particular, La, Pr, Nd, or a combination thereof. In Formula 1, f>g, 0.4≤f≤0.9, and 0.1≤g≤0.6.

In Formula 1, 0.5≤f≤0.8, 0.6≤f≤0.8, or 0.6≤f≤0.75. In Formula 1, 0.1≤g≤0.5, 0.1≤g≤0.4, or 0.1≤g≤0.35.

In Formula 1, 0≤h≤0.15, 0≤h≤0.18, 0<h≤0.1, 0.01≤h≤0.1, 0.01≤h≤0.08, or 0.01≤h≤0.05.

The above-described solid ion conductor includes an oxide having an ABO₃ perovskite structure in which four or more different elements (BaₐSr_{b}M¹_{c}M²_{d}M³ₑ) including Ba and Sr as essential elements are arranged at an A site, and elements (Co_{f}Fe_{g}M⁴ₕ) including Co and Fe as essential elements are arranged at a B site. The oxide may be used as an air electrode material for solid oxide cells with improved durability and cubic phase stability while increasing the concentration of oxygen vacancy within a crystal structure.

In Formula 1, 0 represents an oxygen defect, and is determined to satisfy a charge neutrality condition by considering the oxidation numbers of an A-site cation (BaₐSr_{b}M¹_{c}M²_{d}M³ₑ) and a B-site cation (Co_{f}Fe_{g}M⁴ₕ).

The solid ion conductor according to an embodiment contains barium and strontium as alkali metals, as well as M¹ and M² as essential elements at the A site of the ABO₃ perovskite structure, as represented by Formula 1. A solid ion conductor according to an embodiment optionally includes M³. Barium and strontium existing at the A site induce the formation of oxygen vacancies, and the isolation energy value of barium and strontium on the surface increases due to the high-entropy effect when four or more elements are doped at the A site so that the isolation of barium and strontium may be suppressed. In this way, the surface isolation of barium and strontium cations is suppressed, and thus, a side reaction layer is suppressed or not formed during long-term operation, which significantly reduces performance degradation of the solid ion conductor. Further, rapid oxygen diffusion may be induced by the distortion of an octahedral structure resulting from the bonding of the B-site cation and oxygen. As a result, an oxygen evolution reaction (OER) may occur uniformly in a water electrolysis mode, thereby minimizing a local increase in oxygen partial pressure. As a result, the occurrence of local stress may minimized, and the possibility of interfacial delamination with a solid electrolyte (or reaction barrier layer) may minimized or suppressed.

The solid ion conductor according to an embodiment contains cobalt and iron as essential components at the B site, and optionally contains transition metal M⁴, and the molar content of cobalt is greater than the molar content of iron. The combination of cobalt and iron having d orbitals may be doped at the B site to enhance oxygen adsorption, thereby improving OER and oxygen reduction reaction (ORR) kinetics characteristics. Moreover, the thermal expansion coefficient (TEC) of the solid ion conductor may be reduced by additionally doping M⁴ dopant, and thus, the thermal stability of the solid ion conductor may be further improved.

In the solid ion conductor, when less than four different cations are present at the A site, for example, only two or three cations, suppression of the surface isolation phenomenon of barium and strontium is more difficult to achieve.

In the solid ion conductor according to an embodiment, the content of cobalt is greater than the content of iron.

In Formula 1, 1.1≤f/g≤9.0, 1.1≤f/g≤5.0, 1.15≤f/g≤4.5, 1.2≤f/g≤4.5, 1.5≤f/g≤4.0, 1.7≤f/g≤4.0, or 1.2≤f/g≤3.0. When the mixing ratio of cobalt and iron is in the above-described mixing molar ratio of f/g, excellent structural stability may be achieved, and oxygen ion conductivity and oxygen reduction/generation reaction catalytic properties may be improved.

The ion radii of M¹ and M² are each smaller than the ionic radius of M³. For example, lattice distortion may be minimized and phase stability may be improved by making each of the ionic radii of M¹ and M² smaller than that of M³. The structural stability of the solid ion conductor may be improved. The ionic radii of M¹ and M² may each be, for example, 120 picometer (pm) or less, about 100 μm to about 120 μm, or about 115 μm to about 120 μm. The ionic radius of M³ may be, for example, 310 μm or more, about 330 μm to about 360 μm, or about 130 μm to about 350 μm. The ionic radii of M¹ to M³ are cation ionic radii. The ionic radii of M¹ to M³ may be determined, for example, from the oxidation numbers of M¹ to M³. Alternatively, the ionic radii of M¹ to M³ may be determined by XRD, XPS, EDX, etc.

In Formula 1, M¹ and M² may each independently be lanthanum (La), praseodymium (Pr), yttrium (Y), scandium (Sc), samarium (Sm), gadolinium (Gd), or a combination thereof.

In Formula 1, M³ may be calcium (Ca), magnesium (Mg), radium (Ra), lanthanum (La), praseodymium (Pr), yttrium (Y), or a combination thereof. And, M⁴ may be zinc (Zn), manganese (Mn), ytterbium (Yb), nickel (Ni), copper (Cu), titanium (Ti), holmium (Ho), or a combination thereof.

In accordance with an embodiment of an solid ion conductor of Formula 1, 0.1≤e≤0.4, 0.4≤f≤0.9, 0.1≤g≤0.6, 0≤h<0.2, and 0≤δ<1.

The solid ion conductor according to an embodiment of the disclosure can effectively suppress the segregation of barium and strontium by a high-entropy effect when four or more types of elements are multi-doped at the A site in ABO₃. When four or more different elements are present at the A site, local lattice distortion may occur in a local region without disturbing the overall lattice structure.

The configurational entropy of a metal oxide may be determined by Equation 1 below:

$$Δ {S}_{mix} = - R [ \begin{matrix}{( {\sum }_{a = 1}^{n} {x}_{a} \times ln {x}_{a} )}_{A - site} + \\ {( {\sum }_{b = 1}^{n} {x}_{b} \times ln {x}_{b} )}_{B - site} + \\ 3 {( {\sum }_{t = 1}^{n} {x}_{c} \times ln {x}_{c} )}_{O - site}\end{matrix} ] \qquad Equation 1$$

wherein in Equation 1, A, B, and O represent the number of elements in the A-site cation, B-site cation, and oxygen ion, respectively; xᵢ, xⱼ, and xₖ are mole fractions of the respective elements; and R is the gas constant.

When the configurational entropy of a metal oxide is less than 1R, the metal oxide is defined as a low-entropy oxide. When the configurational entropy of a metal oxide is in the range of 1R to 1.5R, the metal oxide is defined as a middle-entropy oxide. When the configurational entropy of a metal oxide is more than 1.5R, the metal oxide is defined as a high-entropy oxide.

The configurational entropy of the solid ion conductor according to an embodiment exceeds 1.5R, thus satisfying the requirement for the definition of high entropy. In this way, the solid ion conductor according to an embodiment is a material having a stable phase with excellent electrochemical properties as a high-entropy oxide. Further, the solid ion conductor has a low area specific resistance (ASR) value at a temperature of 600 °C or higher, for example, about 600 °C to about 900 °C due to excellent catalytic characteristics for an OER and an ORR, has high crystal structure stability due to a high-entropy effect, and does not cause cation segregation to a surface. Therefore, when using this solid ion conductor, an electrode having improved long-term durability and a solid oxide cell including the same may be manufactured.

In Formula 1, 0.1≤a≤0.4, 0.15≤a≤0.35, 0.2≤a≤0.3, or 0.2≤a≤0.25.

In Formula 1, 0.1≤b≤0.4, 0.15≤b≤0.35, 0.2≤b≤0.3, or 0.2≤b≤0.25.

In Formula 1, 0.1≤c≤0.5, 0.1≤c≤0.4, 0.15≤c≤0.35, 0.2≤c≤0.3, or 0.2≤c≤0.25.

In Formula 1, 0.1≤d≤0.4, 0.15≤d≤0.35, 0.2≤d≤0.3, or 0.2≤d≤0.25.

In Formula 1, 0.1≤e≤0.4, 0.15≤e≤0.35, 0.15≤e≤0.3, or 0.2≤e≤0.25.

In Formula 1, 0.1≤e≤0.4.

In Formula 1, 0.95≤(a+b+c+d+e)≤1, 0.97≤(a+b+c+d+e)≤1, 0.98≤(a+b+c+d+e)≤1, 0.99≤(a+b+c+d+e)≤1, or a+b+c+d+e1=1. When a+b+c+d+e is within the above range, a perovskite oxide form of ABO₃ may be maintained.

In Formula 1, 0.95≤(f+g+h)≤1, 0.97≤(f+g+h)≤1, 0.98≤(f+g+h)≤1, 0.99≤(f+g+h)≤1, or f+g+h=1. When f+g+h is within the above range, a perovskite oxide form of ABO₃ may be maintained.

When M¹ and M² in the solid ion conductor have the above-described contents, the coordination state of remaining elements in the cubooctahedral site, for example, the coordination state of barium and strontium, may be changed. For example, M¹ and M² have reduced ionic radii compared to barium and strontium, thereby reducing the elastic energy due to lattice distortion caused by barium and strontium The phase stability of a crystalline phase of the solid ion conductor may be improved by reduced elastic energy. Since barium and strontium have a changed coordination state, the vaporization and/or diffusion of barium and strontium may be suppressed during the operation of a solid oxide cell including the solid ion conductor. For example, it is possible to suppress crystal phase instability caused by desorption of barium and strontium in the solid ion conductor. Vaporized barium and strontium may cause segregation of barium and strontium, for example, by diffusing into the solid electrolyte layer. Segregated barium and strontium may form an insulating phase between the solid electrolyte layer and the air electrode during the operation of a solid oxide cell. In the solid ion conductor, the presence of M¹ and M² in the above-described contents, suppress the formation of an insulating phase.

In addition, when barium and strontium in the solid ion conductor have the above-described contents, oxygen vacancy concentration may increase, oxygen vacancy ordering may increase, and ion conduction pathway may extend. For example, the formation of defects such as Brownmiller-like phase may be suppressed. When barium and strontium have the above-described content ranges and the contents of barium and strontium decrease, the segregation of barium and strontium may be suppressed more effectively.

In addition, because the solid ion conductor includes cobalt and iron, the activation energy for oxygen transport (e.g., vacancy hoping) in the solid ion conductor may be reduced, and the solid ion conductor may have improved oxygen ion (O²⁻) conductivity. Additionally, the solid ion conductor may be a mixed conductor having ionic conductivity in addition to electronic conductivity.

Because the solid ion conductor is a mixed conductor, active reaction site increase at a two-phase boundary such as solid phase/gas phase or solid phase/solid phase, and a high surface exchange reaction rate may be provided. At the two-phase boundary, the reaction rates (kinetics) of oxygen reduction reaction (ORR) and oxygen evolution reaction (OER) may increase, and the phase stability of a crystal phase may be improved. For example, since an oxygen evolution reaction proceeds uniformly in an electrode, an increase in local oxygen partial pressure in the air electrode may be suppressed, thereby suppressing the local occurrence of stress in the air electrode and/or at the interface between the air electrode and the solid electrolyte layer. For example, the thermal expansion coefficient (TEC) of the solid ion conductor may be lowered. Delamination between the air electrode and the reaction barrier layer and/or the solid electrolyte layer may be suppressed. Deterioration of the solid ion conductor may be suppressed even after long-term operation of a solid oxide cell.

Because the solid ion conductor includes M⁴, the lattice parameter of the solid ion conductor may be reduced Since the solid ion conductor has a reduced lattice parameter, the thermal expansion coefficient (TEC) of the solid ion conductor may be further reduced. For example, the bond strength between the fifth and/or sixth element and oxygen atoms in the octahedral site may be weakened, thereby reducing the activation energy for oxygen hopping. This may result in the solid ion conductor having further improved oxygen ion (O²⁻) conductivity.

In a solid ion conductor according to an embodiment, the molar content of barium, strontium, M¹, M², and M³ may are each essentially the same, i.e., each have essentially the same mole fraction indice, within ±0.05 of each other. In this way, when the contents of all elements arranged at the A site are essentially the same, lattice distortion and/or segregation of barium and/or strontium elements due to differences in these contents can be effectively suppressed.

The solid ion conductor includes a metal oxide, and the metal oxide may include a cubic phase, a hexagonal phase, or a combination thereof. The metal oxide may include a cubic phase. The metal oxide may include a cubic phase, and the phase fraction of the cubic phase may be about 95 wt % to about 100 wt % relative to the total crystalline phase included in the metal oxide. The metal oxide having a cubic phase fraction within this range may result in improved structural stability of the solid ion conductor.

The metal oxide may include a combination of a cubic phase and a hexagonal phase. The phase fraction of the cubic phase may be 95 wt % or more, 97 wt % or more, or 99 wt % or more, relative to the total of the cubic phase and the hexagonal phase. When the metal oxide has a cubic phase fraction within this range, the solid ion conductor may have improved structural stability The phase fraction of the hexagonal phase may be 5 wt % or less, 3 wt % or less, or 1 wt % or less relative to the total of the cubic phase and hexagonal phase.

The metal oxide may be free of a tetragonal phase. Metal oxides including cubic phases have a single perovskite structure. Metal oxides including tetragonal phases have a double-layer perovskite and/or a triple-layer perovskite structure. Metal oxides with a cubic phase in a single perovskite structure are distinct from metal oxides with a tetragonal phase in double-layer and/or triple-layer perovskite structures.

The solid ion conductor may have a composition represented by Formula 1 below:

(Baₐ₁Sr_{b1}Pr_{c1}La_{d1}M³ₑ₁)(Co_{f1}Fe_{g1}M⁴ₕ₁)O_{3-δ} Formula 2
In Formula 2,
M³ may be a cation having an oxidation number of 3+, a group 2 element, a group 5 element, or a combination thereof,
M⁴ may be a transition metal having an oxidation number 2+ or 3+, a group 4 element, a group 7 element, a group 10 to 13 element, a group 16 element, or a combination thereof, and
0.1≤a1≤0.4, 0.1≤b1≤0.4, 0.1≤c1≤0.5, 0.1≤d1≤0.4, 0≤e≤0.4, f1>g1, 0.4≤f1≤0.9, 0.1≤g1≤0.6, 0≤h1≤0.2, 0≤δ<1, 0.9≤(a1+b1+c1+d1+e1)≤1, and 0.95≤)f1+g1+h1)≤1, and δ is an oxygen defect.

The structural stability of the solid ion conductor may be further improved by having the metal oxide having the composition of Formula 2.

In Formula 2, M³ may be Ca, Sr, Ba, Ra, La, Pr, Y, or a combination thereof, and M⁴ may be Ca, Mg, radium (Ra), or a combination thereof.

In Formula 2, 0.1≤c1≤0.5, 0.1≤c1≤0.4, 0.15≤c1≤0.35, 0.2≤c1≤0.3, or 0.2≤c1≤0.25.

In Formula 2, 0.1≤d1≤0.4, 0.15≤d1≤0.35, 0.2≤d1≤0.3, or 0.2≤d1≤0.25. In Formula 2, 0.1≤e1≤0.4, 0.15≤e1≤0.35, 0.15≤e1≤0.3, or 0.2≤e1≤0.25.

In Formula 2, 0.95≤a1+b1+c1+d1+e1≤1, 0.97≤a1+b1+c1+d1+e1≤1, 0.98≤(a1+b1+c1+d1+e1)≤1, 0.99≤(a1+b1+c1+d1+e1)≤1, or a1+b1+c1+d1+e1=1. When a1+b1+c1+d1+e1 is within the above range, a perovskite oxide form of ABO3 may be maintained.

In Formula 2, 0.95≤(f1+g1+h1)≤1, 0.97≤(f1+g1+h1)≤1, 0.98≤(f1+g1+h1)≤1, 0.99≤(f1+g1+h1)≤1, or f1+g1+h1=1. In Formula 2, when f1+g1+h1 is within the above range, a perovskite oxide form of ABO₃ may be maintained.

In Formula 2, 0≤δ<1, 0<δ≤0.8, 0<δ≤0.6, or 0<δ≤0.5.

In Formula 2, M³ may include, for example, Ca, Ra or a combination thereof. When M³ contains such a metal, the oxygen ion conductivity of the solid ion conductor may be further improved.

In Formula 2, the ionic radii of Pr and La may be smaller than the ionic radii of barium (Ba) and strontium (Sr). In this case, for example, lattice distortion may be alleviated, thereby improving the phase stability of the solid ion conductor.

The solid ion conductor includes a metal oxide, and the metal oxide may have a composition of at least one selected from compounds represented by Formulas 3 to 6 below:

(Baₐ₂Sr_{b2}Pr_{c2}La_{d2})(Co_{f2}Fe_{g2})O_{3-δ} Formula 3
wherein, in Formula 3, 0.01≤a2≤0.5, 0.01≤b2≤0.5, 0.01≤c2≤0.5, 0.1≤d2≤0.9, 0.1≤e2≤0.4, f2>g2, 0.4≤f2≤0.9, 0.1≤g2≤0.6, 0≤δ<1, 0.9≤(a2+b2+c2+d2+e2)≤1, and 0.95≤(f2+g2+h2)≤1, and δ is an oxygen defect,

(Baₐ₂Sr_{b2}Pr_{c2}La_{d2}Caₑ₂)(Co_{f2}Fe_{g2})O_{3-δ} Formula 4
wherein, in Formula 4, 0.01≤a2≤0.5, 0.01≤b2≤0.5, 0.01≤c2≤0.5, 0.1≤d2≤0.9, 0.1≤e2≤0.4, f2>g2, 0.4≤f2≤0.9, 0.1≤g2≤0.6, 0≤δ<1, 0.9≤(a2+b2+c2+d2+e2)≤1, and 0.95≤(f2+g2+h2)≤1, and δ is an oxygen defect,

(Baₐ₂Sr_{b2}Pr_{c2}La_{d2}Yₑ₂)(Co_{f2}Fe_{g2})O_{3-δ} Formula 5
wherein, in Formula 5, 0.01≤a2≤0.5, 0.01≤b2≤0.5, 0.01≤c2≤0.5, 0.1≤d2≤0.9, 0.1≤e2≤0.4, f2>g2, 0.4≤f2≤0.9, 0.1≤g2≤0.6, 0≤δ<1, 0.9≤(a2+b2+c2+d2+e2)≤1, and 0.95≤(f2+g2+h2)≤1, and δ is an oxygen defect,

(Baₐ₂Sr_{b2}Pr_{c2}La_{d2}Caₑ₂)(Co_{f2}Fe_{g2}Znₕ₂)O_{3-δ} Formula 6
wherein, in Formula 6, 0.01≤a2≤0.5, 0.01≤b2≤0.5, 0.01≤c2≤0.5, 0.1≤d2≤0.9, 0.1≤e2≤0.4, f2>g2, 0.4≤f2≤0.9, 0.1≤g2≤0.6, 0≤h2<0.2, 0≤δ<1, 0.9≤(a2+b2+c2+d2+e2)≤1, and 0.95≤(f2+g2+h2)≤1, and δ is an oxygen defect.

The structural stability of the solid ion conductor may be further improved by having the metal oxide having a composition of Formulas 3 to 6.

In Formulas 3 to 6, 0.1≤c2≤0.5, 0.1≤c2≤0.4, 0.15≤c2≤0.35, 0.2≤c2≤0.3, or 0.2≤c1≤0.25.

In Formulas 3 to 6, 0.1≤d2≤0.4, 0.15≤d2≤0.35, 0.2≤d2≤0.3, or 0.2≤d2≤0.25.

In Formulas 3 to 6, 0.1≤e2≤0.4, 0.15≤e2≤0.35, 0.15≤e2≤0.3, or 0.2≤e2≤0.25.

In Formulas 3 to 6, 0.95≤(a2+b2+c2+d2+e2)≤1, 0.97≤(a2+b2+c2+d2+e2)≤1, 0.98≤(a2+b2+c2+d2+e2)≤1, 0.99≤(a2+b2+c2+d2+e2)≤1, or a2+b2+c2+d2+e2=1. When a2+b2+c2+d2+e2 is within the above range, a perovskite oxide form of ABO3 may be maintained.

In Formulas 3 to 6, 0≤h2≤0.15, 0≤h2≤0.18, 0<h2≤0.1, 0.01≤h2≤0.1, 0.01≤h2≤0.08, or 0.01≤h2≤0.05.

In Formulas 3 to 6, 0.95≤(f2+g2+h2)≤1, 0.97≤(f2+g2+h2)≤1, 0.98≤(f2+g2+h2)≤1, 0.99≤(f2+g2+h2)≤1, or f2+g2+h2=1. When f2+g2+h2 is within the above range, a perovskite oxide form of ABO₃ may be maintained.

In Formulas 3 to 6, 0≤δ0<1, 0<δ≤0.8, 0<δ≤0.6, or 0<δ≤0.5.

The solid ion conductor according to an embodiment may be, for example, Pr_{0.25}Ba_{0.25}La_{0.25}Sr_{0.25}Co_{0.6}Fe_{0.4}O₃, Pr_{0.2}Ba_{0.2}La_{0.2}Sr_{0.2}Ca_{0.2}Co_{0.6}Fe_{0.4}O₃, Pr_{0.2}Ba_{0.2}La_{0.2}Sr_{0.2}Y_{0.2}Co_{0.6}Fe_{0.4}O₃, Pr_{0.2}Ba_{0.2}La_{0.2}Sr_{0.2}Ca_{0.2}Co_{0.6}Fe_{0.35}Zn_{0.05}O₃, or Pr_{0.2}Ba_{0.2}La_{0.2}Sr_{0.2}Ca_{0.2}Co_{0.8}Fe_{0.2}O_{2.56}.

The area-specific resistance (ASR) of the solid ion conductor according to an embodiment, as measured at 700 °C using an alternating current impedance method, may be 0.5 Ω/cm² or less, 0.3 Ω/cm² or less, 0.1 Ω/cm² or less, or 0.05 Ω/cm² or less. The ASR may be an area-specific resistance for polarization resistance. The ASR may be measured using the alternating current impedance method in a symmetric cell including the solid ion conductor.

Additionally, the activation energy of the solid ion conductor may be 0.5 eV or less, about 0.1 eV to about 0.5 eV, or about 0.2 eV to about 0.4 eV. Activation energy may be evaluated using the same method as described in Evaluation Examples to be described later.

The thermal expansion coefficient (TEC) of the solid ion conductor may be 20×10⁻⁶/K or less, 17×10⁻⁶/K or less, or 15×10⁻⁶/K or less. By having such a thermal expansion coefficient, the solid ion conductor may suppress delamination caused by the difference in thermal expansion coefficients between the reaction barrier layer and/or the solid electrolyte layer and the air electrode in a solid oxide cell operating at high temperatures. As a result, the thermal stability of solid oxide cells may be improved.

The solid ion conductor may be a single crystalline structure including a single crystalline phase, or a polycrystalline structure. According to an embodiment, the solid ion conductor is, for example, a single crystal including a crystalline phase.

Alternatively, the solid ion conductor may, in addition to the above-described metal oxide of Formula 1, further include a composite of an ion-conductive metal oxide that is distinct from this metal oxide, and the metal oxide of Formula 1. Examples of the ion-conductive metal oxide distinct from the metal oxide of Formula 1 may include, but are not limited to, neodymium-doped ceria (NDC), gadolinium-doped ceria (GDC), samarium-doped ceria (SDC), yttria-stabilized zirconia (YSZ), scandia-stabilized zirconia (ScSZ, ZrO₂/SC₂O₃), strontium- and magnesium-doped lanthanum gallate (LSGM), and combinations thereof.

The solid ion conductor may include a composite phase of an ion-conductive metal oxide distinct from the metal oxide of Formula 1 and the metal oxide of Formula 1. The solid ion conductor may include a composite phase including the cubic phase corresponding to the metal oxide of Formula 1 and the aforementioned composite. The solid ion conductor may include multiple crystalline phases. The solid ion conductor may be a polycrystalline structure that includes multiple crystalline phases.

According to another aspect, there is provided an electrode including a solid ion conductor, wherein the solid ion conductor includes a metal oxide having a perovskite structure, the metal oxide includes four or more different elements arranged in a cubooctahedral site of the perovskite structure, where the four or more different elements include i) barium (Ba), strontium (Sr), and M¹ and M² elements or ii) barium (Ba), strontium (Sr), and M¹, M² and M³ elements, the metal oxide includes cobalt (Co) and iron (Fe), or ii) cobalt (Co), iron (Fe), and M⁴, arranged in the octahedral site of the perovskite structure, M¹ and M² are each independently a cation having an oxidation number of 3+, a lanthanide element, a group 3 element, a group 5 element, a group 8 element, a group 10 element, or a combination thereof, M³ is a cation having an oxidation number 2+ or 3+, a group 2 element, a group 5 element, or a combination thereof, M⁴ is a transition metal having an oxidation number 2+ or 3+, a group 4 element, a group 7 element, a group 10 to 13 element, a group 16 element, or a combination thereof, molar content of elements barium, strontium, M¹ and M² are each 0.5 or less with respect to a total of the elements barium, strontium, M¹ and M²; or molar content of elements barium (Ba), strontium (Sr), M¹, M² and M³ are each 0.5 or less with respect to a total of the elements barium (Ba), strontium (Sr), M¹, M² and M³, and a molar content of cobalt (Co) is equal to or greater than a molar content of iron (Fe).

Electrodes including solid ionic conductors may be used in electrochemical devices. Electrochemical devices may be metal oxide cells, metal-air cells, gas sensors, capacitors, and the like. Electrodes including the solid ion conductor may serve as a positive electrode, a negative electrode, a cathode, an anode, an air electrode, or a fuel electrode.

An electrode including the solid ionic conductor may be air electrode.

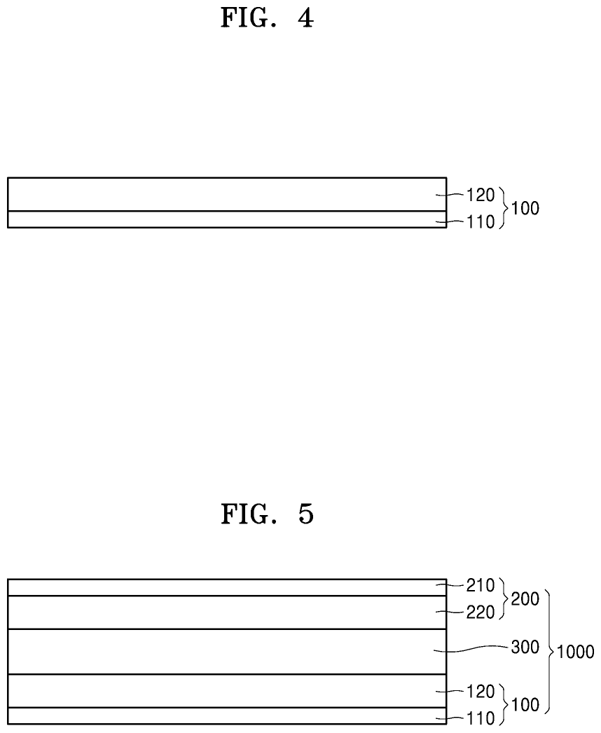

FIG. 4 is a schematic cross-sectional view of an air electrode according to an embodiment. Referring to FIG. 4, an air electrode 100 includes an air electrode current collector 110 and a catalyst layer 120 disposed on the air electrode current collector 110. The catalyst layer 120 may include a solid ion conductor.

The air electrode collector 110 may be a porous conductor including a plurality of pores. The air electrode collector 110 may include a metal mesh, a metal foam, a metal powder assembly, a porous carbon structure, or a combination thereof. The metal mesh, metal foam or metal powder assembly may include stainless steel, nickel (Ni), cobalt (Co), manganese (Mn), aluminum (AI), indium (In), copper (Cu), magnesium (Mg), titanium (Ti), iron (Fe), zinc (Zn), germanium (Ge), silver (Ag), gold (Au), platinum (Pt) or alloys thereof. The metal mesh or metal foam may include a stainless steel skeleton and a coating layer disposed on a surface of the skeleton, wherein the coating layer may include nickel (Ni), cobalt (Co), manganese (Mn), aluminum (AI), indium (In), copper (Cu), magnesium (Mg), titanium (Ti), iron (Fe), zinc (Zn), germanium (Ge), silver (Ag), gold (Au), platinum (Pt) or an alloy thereof.

The air electrode catalyst layer 120 may include a solid ion conductor including the first to fifth elements and/or sixth element described above as a catalyst. The air electrode catalyst layer 120 may be formed by preparing an air electrode catalyst layer slurry including a solid ion conductor and a solvent, applying the slurry onto a substrate, and sintering the applied slurry. The substrate may be an air electrode collector 110 or a solid electrolyte layer (not shown). Since the solid ion conductor is a mixed conductor having excellent ion conductivity and electron conductivity, the solid ion conductor may act as a catalyst for oxygen reduction reaction and/or oxygen evolution reaction at the air electrode. Because the solid ion conductor has improved structural stability deterioration of the air electrode catalyst layer 120 may be suppressed even after long-term operation. The durability of the air electrode 100 may be improved.

The air electrode catalyst layer 120 may further include a binder or a conductive material.

Examples of the binder include vinylidene fluoride/hexafluoropropylene copolymer (PVDF-HFP), polyvinylidene fluoride (PVDF), polyacrylonitrile (PAN), polymethyl methacrylate (PMMA), polytetrafluoroethylene (PTFE), polyacrylic acid (PAA), polyvinyl alcohol (PVA), carboxymethyl cellulose (CMC), starch, hydroxypropyl cellulose, regenerated cellulose, polyvinylpyrrolidone, tetrafluoroethylene, polyethylene, polypropylene, ethylene-propylene-diene monomer (EPDM), sulfonated EPDM, styrene-butadiene-rubber, fluorinated rubber, copolymers thereof, or a combination thereof. The content of the binder may be about 1 part by weight to about 10 parts by weight, or about 2 parts by weight to about 7 parts by weight, per 100 parts by weight of the solid ion conductor. The binder may be partially or completely removed by vaporization and/or carbonization during the sintering process of the air electrode catalyst layer 120. The binder may be omitted.

The conductive material may include a carbon-based conductive material. Examples of the carbon-based conductive material include carbon black, carbon fibers, graphite, fluorocarbon, or a combination thereof. Examples of carbon black include acetylene black, Ketjen black, Super P carbon, channel black, furnace black, lamp black, thermal black or a combination thereof. Graphite may be natural or artificial graphite. The air electrode catalyst layer 120 may further include a metal-based conductive material, a metal oxide-based conductive material, or a polymer-based conductive material in addition to the carbon-based conductive material described above. Examples of the metal-based conductive material include a metal fiber, a metal powder such as aluminum powder or nickel powder, a conductive metal oxide such as zinc oxide or potassium titanate, or a polyethylene derivative. The content of the conductive material may be about 1 part by weight to about 10 parts by weight, or about 2 parts by weight to about 7 parts by weight, per 100 parts by weight of the solid ion conductor. The conductive material may be omitted.

The air electrode catalyst slurry may include a solvent. The solvent may include terpineol, but is not limited thereto.

In the air electrode 100, depending on the operating mode, the oxygen reduction reaction (ORR) represented by Reaction Scheme 1, the oxygen evolution reaction (OER) represented by Reaction Scheme 2, or both reactions may occur.

½O₂+H₂O+2e−→2OH⁻ Reaction Scheme 1

2OH⁻→½O₂+H₂O+2e⁻ Reaction Scheme 2

In the fuel cell mode of a solid oxide cell, an oxygen reduction reaction may be performed at the air electrode. In the electrolysis cell mode of a solid oxide cell, an oxygen evolution reaction may be performed at the air electrode. At the air electrode of a metal-air cell, an oxygen evolution reaction occurs during charging, and an oxygen reduction reaction occurs during discharging.

According to another embodiment, a solid oxide cell includes an air electrode, a fuel electrode, and a solid electrolyte layer disposed between the air electrode and the fuel electrode, wherein at least one of the air electrode, the fuel electrode, and the solid electrolyte layer includes the solid ion conductor described herein.

Examples of the solid oxide cell include a solid oxide fuel cell or a solid oxide electrolyzer cell.

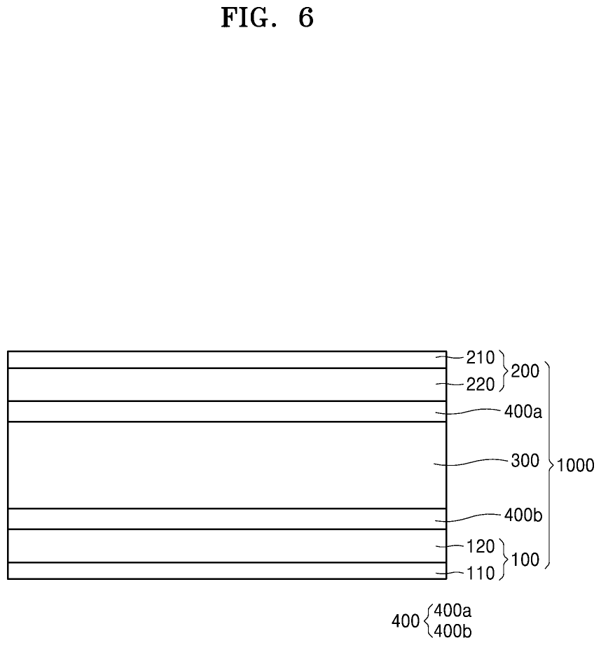

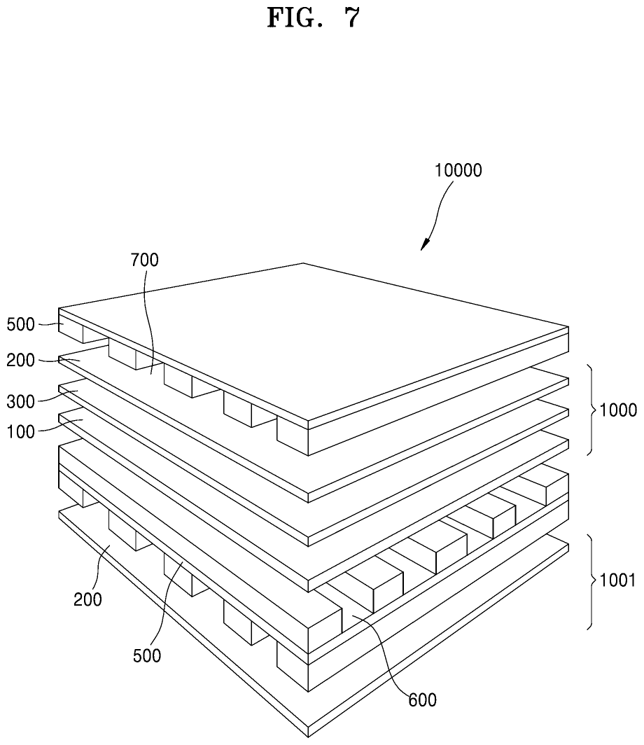

FIGS. 5 and 6 are schematic views showing a solid oxide cell 1000 according to an embodiment. The solid oxide cell may operate in both fuel cell mode, where oxygen reduction reactions occur, and electrolysis cell mode, where oxygen evolution reactions occur. For example, depending on the required conditions, the cell may generate electricity in fuel cell mode or produce fuel in electrolysis cell mode. Referring to FIGS. 6 and 7, the solid oxide cell includes an air electrode 100, a fuel electrode 200, and a solid electrolyte layer 300 disposed between the air electrode 100 and the fuel electrode 200.

The air electrode 100 may perform oxygen reduction reactions and/or oxygen evolution reactions. The air electrode 100 includes an air electrode current collector 110 and an air electrode catalyst layer 120.

Detailed descriptions of the air electrode current collector 110 and the air electrode catalyst layer 120 are provided in the earlier sections describing the electrode.

The air electrode catalyst layer 120 may additionally include a solid ion conductor that is distinct from the solid ion conductor including the first to fifth elements and/or sixth element described above. The solid ion conductor added to the air electrode catalyst layer 120 may be selected from among the solid ion conductors used in the solid electrolyte layer 300 described below.

The solid electrolyte layer 300 is a solid oxide electrolyte layer. The solid electrolyte layer 300 includes a solid ion conductor, and the solid ion conductor may include an oxygen ion conductor, a proton conductor, or a mixture thereof. The solid electrolyte layer 300 may include a solid ion conductor including the first to fifth elements and/or sixth element described above as an oxygen ion conductor.

The solid electrolyte layer 300 may include an oxygen ion conductive metal oxide as an oxygen ion conductor. Examples of the oxygen ion conducting metal oxide include rare-earth-doped ceria (RDC) such as neodymium-doped ceria (NDC), gadolinium-doped ceria (GDC), samarium-doped ceria (SDC); yttria stabilized zirconia (YSZ, ZrO₂/Y₂O₃); scandia stabilized zirconia (ScSZ, ZrO₂/Sc₂O₃); and strontium- and magnesium-doped lanthanum gallate (LSGM) or a combination thereof. A solid oxide cell employing a solid electrolyte layer 300 including an oxygen ion conductor may be an oxygen ion conductive solid oxide cell.

The solid electrolyte layer 300 may include a proton-conducting metal oxide as a protoconductor. Examples of the proton-conducting metal oxide include one or more selected from trivalent element-doped barium zirconate (BaZrO₃), barium cerate (BaCeO₃), barium zirconate cerate (BaZr₁₋ₓCeₓO3, where 0.05≤x≤0.95), strontium cerate (SrCeO₃), strontium zirconate (SrZrO₃), and strontium zirconate cerate (SrZr₁₋ₓCeₓO₃, where 0.05≤x≤0.95). The trivalent element doped in the proton conductor may include yttrium (Y), a lanthanide, or a combination thereof. Lanthanide element may include ytterbium (Yb). Examples of the proton conductor include yttrium (Y)-doped barium zirconate, yttrium (Y) and ytterbium (Yb)-doped barium zirconate cerate, or a combination thereof. Examples of proton conductors include BaZr₁₋ₓYₓO_{3-δ} (where 0.1≤x≤0.2, 2≤δ<3), BaZr_{0.1}Ce_{0.7}Y_{0.1}Yb_{0.1}O_{2.95}. A solid oxide cell employing a solid electrolyte layer 300 including a proton conductor may include a proton-conductive solid oxide cell.

A solid oxide cell employing a solid electrolyte layer 300 including a mixture of oxygen ion conductors and proton conductors may include a mixed-conductive solid oxide cell.

The fuel electrode 200 may provide fuel diffusion and electron conduction. Examples of the fuel may include hydrogen, water (gas) or carbon dioxide. The fuel electrode 200 may include a fuel electrode current collector 210 and a fuel electrode catalyst layer 220 disposed on the fuel electrode current collector 210. The fuel electrode current collector 210 may be selected from a metal mesh, metal foam, metal powder assembly, or porous carbon structure, used in the air electrode current collector 110. The material of the fuel electrode current collector 220 may be selected from the materials used for the air electrode current collector 110.

The fuel electrode catalyst layer 220 may include the solid ion conductor including the first to fifth elements and/or sixth element described above.

The fuel electrode catalyst layer 220 may also include a solid ion conductor distinct from the aforementioned solid ion conductor including the first to fifth elements and/or sixth element. Examples of the solid ion conductor include an oxygen ion conductor, a proton conductor, or a mixture thereof. The oxygen ion conductor, proton conductor or mixture thereof added to the fuel electrode catalyst layer 220 may be selected from the oxygen ion conductor, proton conductor or mixture thereof used in the solid electrolyte layer 300.

The fuel electrode catalyst layer 220 may further include a catalytic metal.

The catalytic metal may enhance the electronic conductivity of the fuel electrode catalyst layer 220 and facilitate the generation of protons and electrons from the fuel or the production of fuel from protons and electrons. Examples of the catalytic metal may include a transition metal. Examples of the catalytic may metal include Ni, Cu, Pt, Pd, or a combination thereof.

The fuel electrode catalyst layer 220 may further include a carbonaceous material.

The fuel electrode catalyst layer 220 may be prepared by mixing catalytic metal oxides, a solid ion conductor, and optionally a precursor of carbonaceous material, followed by sintering. The catalytic metal oxide may be reduced to a catalytic metal by hydrogen supplied before the operation of the solid oxide cell, and it may be present in the reduced state within the fuel electrode catalyst layer 220.

The solid oxide cell 1000 may operate at about 500 °C to about 1100 °C At such operating temperatures, the solid electrolyte layer 300 may provide sufficiently high oxygen ion conductivity and/or proton conductivity.

Referring to FIG. 6, the solid oxide cell 1000 may further include a reaction barrier layer 400, 400a, 400b between the solid electrolyte layer 300 and the air electrode 100 and/or between the solid electrolyte layer 300 and the fuel electrode 200.

The reaction barrier layer 400, 400a, 400b may prevent side reactions between the solid electrolyte layer 300 and the air electrode 100 and/or the fuel electrode 200, thereby improving the durability of the solid oxide cell 1000.

The reaction barrier layer 400, 400a, 400b may include a solid ion conductor. The solid ion conductor used in the reaction barrier layer 400, 400a, 400b may be selected from an oxygen ion conductor, a proton conductor, or a mixture thereof, used in the solid electrolyte layer 300. The solid ion conductor used in the reaction barrier layer 400, 400a, 400b may have a composition distinct from the solid ion conductor used in the solid electrolyte layer 300. Therefore, the reaction barrier layer 400, 400a, 400b may suppress side reactions between the solid ion conductor of the solid electrolyte layer 300 and the air electrode 100, thereby enhancing the durability of the solid oxide cell 1000.

The solid oxide cell 1000 may operate in fuel cell mode, where fuel is supplied to the fuel electrode 200 and air is supplied to the air electrode 100 to produce electricity.

The solid oxide cell 1000 may operate in electrolysis cell mode, where an electric field is applied between the fuel electrode 200 and the air electrode 100 to produce fuel at the fuel electrode 200. The electrolysis cell mode may be referred to as a hydrogen production mode or alternatively as a water-splitting mode.

Oxygen ion-conductive solid oxide cells may operate in dual mode, i.e., fuel cell mode and electrolysis cell mode, through the following reaction.

### (Fuel Cell Mode)

H₂+O²⁻→H₂O+2^{e-} Fuel electrode:

½O₂+2e−→O²⁻ Air electrode:

### (Oxygen Reduction Reaction, ORR)—Electrolysis Cell Mode

H₂O+2e−→H₂+O²⁻ Fuel electrode:

O²⁻→½O₂+2e−; (Oxygen evolution reaction, OER) Air electrode:

Proton-conductive solid oxide cells may operate in dual mode, i.e., fuel cell mode and electrolysis cell mode, through the following reaction.

### (Fuel Cell Mode)

H₂→2H⁺+2e⁻ Fuel electrode:

2H⁺+½O₂₊₂e⁻→H₂O Air electrode:

### (Electrolysis Cell Mode)

2H++2e⁻→H₂ Fuel electrode:

H₂O→2H⁺+½O₂₊₂e⁻; (Oxygen evolution reaction, OER) Air electrode:

FIG. 7 is a schematic view of a solid oxide cell stack 1000 according to another embodiment.

Referring to FIG. 7, a solid oxide cell stack 10000 includes a plurality of solid oxide cells 1000, 1001 stacked in the thickness direction. Each solid oxide cell 1000, 1001 includes an air electrode 100, a fuel electrode 200, and a solid electrolyte layer 300 therebetween. A plurality of solid oxide cells 1000, 1001 are stacked in the thickness direction, and an interconnector 500 is arranged between adjacent solid oxide cells 1000, 1001. The interconnector 500 may include an air passage 600 arranged adjacent to the air electrode 100 and a fuel passage 700 arranged adjacent to the fuel electrode 200. Through the air passage 600, fluid such as air or oxygen may be supplied to the air electrode 100, or fluid such as oxygen may be discharged. Through the fuel passage 700, fuel fluids such as hydrogen, water and carbon dioxide may be supplied to the fuel electrode 200, or fluids such as hydrogen and carbon monoxide may be discharged.

The interconnector 500 may be an electrical conductor. The interconnector 500 may contain metal. The interconnector 500 may exhibit oxidation resistance against the fluids supplied to the air electrode 100 and the fuel electrode 200 at the operating temperature of the solid oxide cell 1000. The interconnector 500 may also have a thermal expansion coefficient (TEC) that is similar to or identical to the TEC of the ceramic components included in the solid electrolyte layer 300 of the solid oxide cell 1000, 10001. For example, ferritic alloy steel that forms a chromium oxide surface layer may be used as the interconnector 500.

Hereinafter, a method of manufacturing a solid ion conductor according to an embodiment will be described.

Solid ion conductors may be manufactured by a liquid-phase synthesis method or a solid-phase synthesis method. The liquid-phase synthesis method may include, for example, a Pechini synthesis method.

In order to manufacture a solid ion conductor according to an embodiment, first, precursors for forming a solid ion conductor are mixed to obtain a precursor mixture. For the mixing, solid-phase mixing or liquid-phase mixing may be used. In the solid-phase mixing, mechanical milling may be performed using a ball mill. In the liquid-phase mixing, an organic solvent may be used. The liquid-phase mixing may be performed using the above-described Pechini synthesis method.

Next, a solid ion conductor may be manufactured by including a process of heat-treating the precursor mixture.

When performing the liquid-phase synthesis method according to the Pechini synthesis method, a process of mixing a complexing agent and deionized water with the precursor mixture to prepare a precursor composition may be further included after the process of preparing the precursor mixture.

The process of heat-treating the precursor mixture may include a process of first heat-treating the precursor composition at a first temperature to prepare a gelled powder; and a process of second heat-treating the gelled powder at a second temperature.

Precursors for forming a solid ion conductor include a barium precursor, a strontium precursor, an M¹ precursor, an M² precursor, a cobalt precursor, and an iron precursor. The precursors for forming a solid ion conductor may further include an M³ precursor and/or an M⁴ precursor.

The content of the barium precursor, the strontium precursor, the M¹ precursor, the M² precursor, the cobalt precursor, the iron precursor, the M³ precursor and/or the M⁴ precursor may be controlled to a stoichiometric content corresponding to the composition of Formula 1.

(BaₐSr_{b}M¹_{c}M²_{d}M³ₑ)(Co_{f}Fe_{g}M⁴ₕ)O_{3-δ} Formula 1

In Formula 1, M¹ and M² may each independently be a cation having an oxidation number of 3+, a lanthanide element, a group 3 element, a group 5 element, a group 8 element, a group 10 element, or a combination thereof,

M³ may be a cation having an oxidation number 2+ or 3+, a group 2 element, a group 5 element, or a combination thereof,

M⁴ may be a transition metal having an oxidation number 2+ or 3+, a group 4 element, a group 7 element, a group 10 to 13 element, a group 16 element, or a combination thereof, and 0.1≤a≤0.4, 0.1≤b≤0.4, 0.1≤c≤0.5, 0.1≤d≤0.4, 0≤e≤0.4, f>0, g>0, f>g, 0≤h<0.2, 00<1, 0.9≤(a+b+c+d+e)≤1, and 0.9≤(f+g+h)≤1.

The barium precursor, strontium precursor, M¹ precursor, M² precursor, cobalt precursor, iron precursor, M³ precursor, and M⁴ precursor may be, for example, an oxide, sulfate, chloride, hydroxide, acetate, carbonate, phosphate, oxalate, or a combination thereof containing barium, strontium, M¹, M², cobalt, iron, M³, and M⁴, respectively.

A complexing agent and deionized water are mixed with the precursor mixture to prepare a precursor composition. Citric acid or the like may be used as the complexing agent.

The precursor composition is first heat-treated at a first temperature to obtain a gelled powder.

The first heat treatment temperature may vary depending on the composition of the precursor composition, but is performed at about 200 °C to about 450 °C, for example, about 250 °C to about 400 °C

This gelled powder is second heat-treated at a second temperature, to prepare a solid ion conductor powder having a composition represented by Formula 1. The second heat treatment temperature may vary depending on the composition of the precursor composition, but is in a range of about 600 °C to about 1200 °C, or about 1000 °C to about 1100 °C

The above-described heat treatments may be performed in an inert gas atmosphere or an oxidative gas atmosphere. Here, the inert gas atmosphere may be carried out under nitrogen or helium gas, and the oxidative gas atmosphere may be carried out under air or the atmosphere.

Hereinafter, the disclosure will be described in detail with reference to examples and comparative examples, but is not limited to the following examples.

### (Manufacture of Solid Ion Conductors)

### Example 1: Pr_{0.25}Ba_{0.25}La_{0.25}Sr_{0.25}Co_{0.6}Fe_{0.4}O₃(4 Types & Co>Fe, Co:Fe=1.5:1)

### Preparation of Solid Ion Conductor Powder

Solid ion conductor precursors, Pr(NO₃)₃-6H₂O, La(NO₃)₃-6H₂O, Sr(NO₃)₂, BaN₂O₆, Co(NO₃)₂·6H₂O, and Fe(NO₃)₃-9H₂O, were mixed in a stoichiometric ratio to prepare a precursor mixture. The prepared precursor mixture was mixed with citric acid in a weight ratio of 1:1, added to distilled water, and then stirred to prepare a precursor solution.

The precursor solution was evaporated in an air atmosphere in an oven at 350 °C to prepare a gelled powder. The gelled powder was calcined in a furnace at 1000 °C for 4 hours in an air atmosphere to prepare a solid ion conductor in powder form with the composition disclosed in Table 1. The composition of the manufactured solid ion conductor was Pr_{0.25}Ba_{0.25}La_{0.25}Sr_{0.25}Co_{0.6}Fe_{0.4}O₃.

### Manufacture of Electrodes and Solid Oxide Cells

YSZ powder was put into a pelletizer, pressed using uniaxial pressure, and sintered in an air atmosphere at 1450 °C for 5 hours to prepare YSZ pellets with a thickness of 0.5 mm.

GDC (Ce_{0.9}Gd_{0.1}O₂, BET: 11.8 m²/g, FCM, USA) paste was applied on both sides of the YSZ pellet using a screen-printing method and sintered in an air atmosphere at 1200 °C for 2 hours to prepare a first laminate with a reaction barrier layer (GDC layer)/solid electrolyte layer (YSZ layer)/reaction barrier layer (GDC layer) structure.

The solid ion conductor powder from above was ball-milled to prepare milled solid ion conductor powder. The milled solid ion conductor powder and an ink vehicle solution (FCM) at a weight ratio of 2:1 were mixed to prepare a solid ion conductor paste. The solid ion conductor paste was applied on the reaction barrier layer of the first laminate using a screen-printing method and sintered in an air atmosphere at 900 °C for 2 hours to prepare a second laminate. The second laminate had an air electrode/reaction barrier layer (GDC layer)/solid electrolyte layer (YSZ layer)/reaction barrier layer (GDC layer)/air electrode structure. Ag paste (H4580, Shoei Chemical, Japan) was applied on both air electrode surfaces of the second laminate, and Ag mesh and wires were connected to manufacture a solid oxide cell.

### Example 2: Pr_{0.2}Ba_{0.2}La_{0.2}Sr_{0.2}Ca_{0.2}Co_{0.6}Fe_{0.4}O₃(Containing Ca in A Site, Co:Fe=1.5:1)

A solid ion conductor, an air electrode, and a solid oxide cell were each manufactured using the same method as in Example 1, except for changing the stoichiometric ratios of the solid ion conductor precursors.

The composition of the manufactured solid ion conductor was Pr_{0.2}Ba_{0.2}La_{0.2}Sr_{0.2}Ca_{0.2}Co_{0.6}Fe_{0.4}O₃.

### Example 3: Pr_{0.2}Ba_{0.2}La_{0.2}Sr_{0.2}Y_{0.2}Co_{0.6}Fe_{0.4}O₃(Containing Y in A Site, Co:Fe=1.5:1)

A solid ion conductor, an air electrode, and a solid oxide cell were each manufactured using the same method as in Example 1, except for adding Y(NO₃)₂·6H₂O and changing the stoichiometric ratios of the precursors when preparing the precursor mixture.

The composition of the manufactured solid ion conductor was Pr_{0.2}Ba_{0.2}La_{0.2}Sr_{0.2}Y_{0.2}Co_{0.6}Fe_{0.4}O₃.

### Example 4: Pr_{0.2}Ba_{0.2}La_{0.2}Sr_{0.2}Ca_{0.2}Co_{0.6}Fe_{0.35}Zn_{0.05}O₃ (Containing Zn in B Site, Co:Fe=1.7:1)

A solid ion conductor, an air electrode, and a solid oxide cell were each manufactured using the same method as in Example 1, except for adding Ca(NO₃)₃-6H₂O and Zn(NO₃)₃-6H₂O and changing the stoichiometric ratios of the precursors when preparing the precursor mixture.

The composition of the manufactured solid ion conductor was Pr_{0.2}Ba_{0.2}La_{0.2}Sr_{0.2}Ca_{0.2}Co_{0.6}Fe_{0.35}Zn_{0.05}O₃.

### Example 5: Pr_{0.2}Ba_{0.2}La_{0.2}Sr_{0.2}Ca_{0.2}Co_{0.8}Fe_{0.2}O_{2.56} (Co:Fe=4:1)

A solid ion conductor, an air electrode, and a solid oxide cell were each manufactured using the same method as in Example 1, except for changing the stoichiometric ratios of the contents of the cobalt precursor and the iron precursor so as to prepare Pr_{0.2}Ba_{0.2}La_{0.2}Sr_{0.2}Ca_{0.2}Co_{0.8}Fe_{0.2}O_{2.56}(Co:Fe=4:1).

### Comparative Example 1: Pr_{0.2}Ba_{0.2}La_{0.2}Sr_{0.2}Ca_{0.2}CoO₃(A Site: 4 Types & no Fe)

### (Preparation of Solid Ion Conductor Powder)

A solid ion conductor, an air electrode, and a solid oxide cell were each manufactured using the same method as in Example 1, except for mixing the solid ion conductor precursors Pr(NO₃)₃-6H₂O, La(NO₃)₃-6H₂O, Sr(NO₃)₂, BaN₂O₆, Co(NO₃)₂·6H₂O, and Ca(NO₃)₂·6H₂O in a stoichiometric ratio to prepare a precursor mixture so as to manufacture Pr_{0.2}Ba_{0.2}La_{0.2}Sr_{0.2}Ca_{0.2}CoO₃.

### Comparative Example 2: Pr_{0.2}Ba_{0.2}La_{0.2}Sr_{0.2}Ca_{0.2}Co_{0.2}Fe_{0.8}O₃(A site: 5 types & Co<Fe, Co:Fe=1:4)

A solid ion conductor, an air electrode, and a solid oxide cell were each manufactured using the same method as in Example 1, except for changing the stoichiometric ratio of solid iron conductor precursor so as to manufacture Pr_{0.2}Ba_{0.2}La_{0.2}Sr_{0.2}Ca_{0.2}Co_{0.2}Fe_{0.8}O₃.

The composition of the manufactured solid ion conductor was Pr_{0.2}Ba_{0.2}La_{0.2}Sr_{0.2}Ca_{0.2}Co_{0.2}Fe_{0.8}O₃.

### Comparative Example 3: La_{0.6}Sr_{0.4}CoO₃

A solid ion conductor, an air electrode, and a solid oxide cell were each manufactured using the same method as in Example 1, except for mixing La(NO₃)₃-6H₂O, Sr(NO₃)₂, and Co(NO₃)·6H₂O in a stoichiometric ratio to prepare a mixture so as to manufacture La_{0.6}Sr_{0.4}CoO₃. The composition of the manufactured solid ion conductor was La_{0.6}Sr_{0.4}CoO₃.

### Reference Example 1: Pr_{0.5}Ba_{0.25}Sr_{0.25}Co_{0.6}Fe_{0.4}O₃(A Site: 3 Types & Co>Fe, Co:Fe=1.5:1)

A solid ion conductor, an air electrode, and a solid oxide cell were each manufactured using the same method as in Example 1, except for mixing the solid ion conductor precursors Pr(NO₃)₃-6H₂O, Sr(NO₃)₂, BaN₂O₆, Co(NO₃)₂·6H₂O, and Fe(NO₃)₃₋₉H₂O in a stoichiometric ratio to prepare a precursor mixture so as to manufacture Pr_{0.5}Ba_{0.25}Sr_{0.25}Co_{0.6}Fe_{0.4}O₃. The composition of the manufactured solid ion conductor was Pr_{0.5}Ba_{0.25}Sr_{0.25}Co_{0.6}Fe_{0.4}O₃.

The compositions of the solid ion conductors manufactured in Examples 1 to 5, Comparative Examples 1 to 3, and Reference Example 1 are summarized in Table 1 below.

TABLE 1

| Class. | Composition |
|---|---|
| Example 1 | Pr_{0.25}Ba_{0.25}La_{0.25}Sr_{0.25}Co_{0.6}Fe_{0.4}O₃ |
| Example 2 | Pr_{0.2}Ba_{0.2}La_{0.2}Sr_{0.2}Ca_{0.2}Co_{0.6}Fe_{0.4}O₃ |
| Example 3 | Pr_{0.2}Ba_{0.2}La_{0.2}Sr_{0.2}Y_{0.2}Co_{0.6}Fe_{0.4}O₃ |
| Example 4 | Pr_{0.2}Ba_{0.2}La_{0.2}Sr_{0.2}Ca_{0.2}Co_{0.6}Fe_{0.35}Zn_{0.05}O₃ |
| Example 5 | Pr_{0.2}Ba_{0.2}La_{0.2}Sr_{0.2}Ca_{0.2}Co_{0.8}Fe_{0.2}O_{2.56} |
| Comparative | Pr_{0.2}Ba_{0.2}La_{0.2}Sr_{0.2}Ca_{0.2}CoO₃ |
| Example 1 | |
| Comparative | Pr_{0.2}Ba_{0.2}La_{0.2}Sr_{0.2}Ca_{0.2}Co_{0.2}Fe_{0.8}O₃ |
| Example 2 | |
| Comparative | La_{0.6}Sr_{0.4}CoO₃ |
| Example 3 | |
| Reference | Pr_{0.5}Ba_{0.25}Sr_{0.25}Co_{0.6}Fe_{0.4}O₃ |
| Example 1 | |

### Evaluation Example 1: X-Ray Diffraction (XRD) Analysis

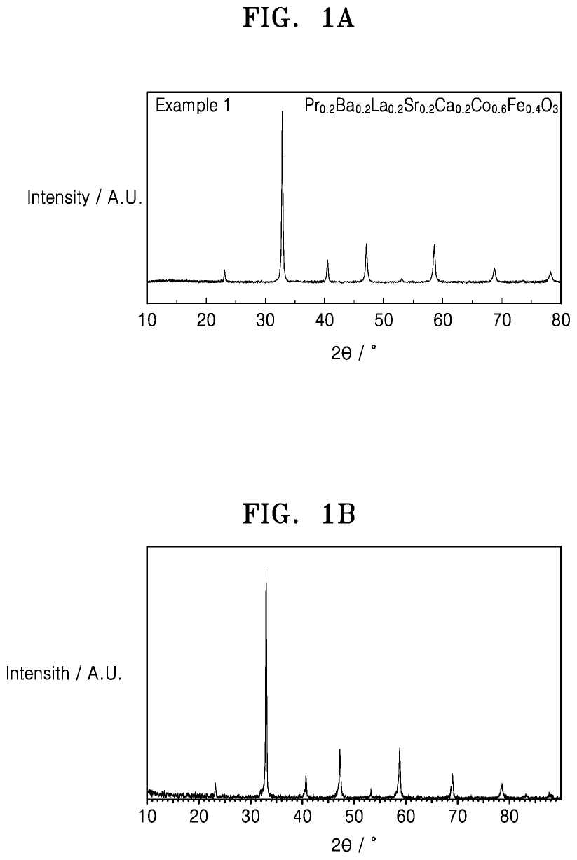

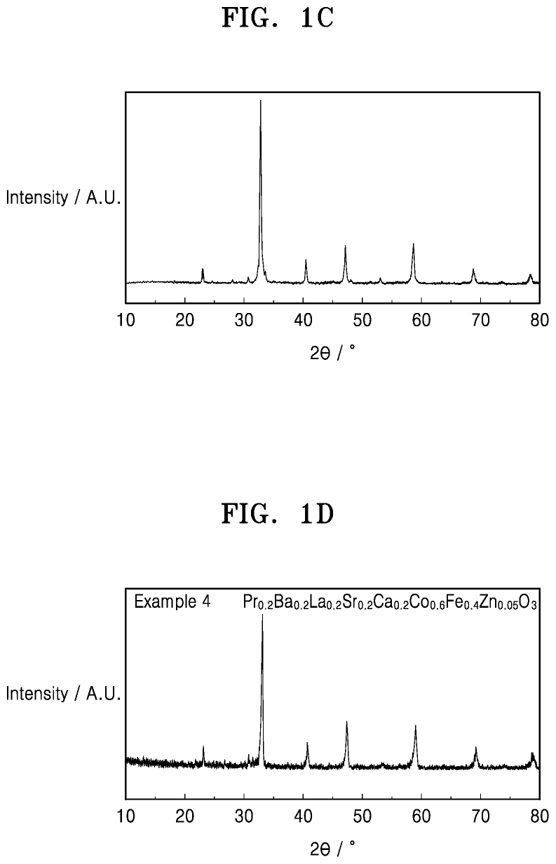

The XRD spectra of the solid ion conductors manufactured in Examples 1 to 4 were measured, and some of the results are shown in FIGS. 1A to 1D. The XRD spectra were measured using X′pert Pro (PANalytical) with Cu Kα radiation (1.54056 Å).

As shown in FIGS. 1A to 1D, the solid ion conductors manufactured in Examples 1 to 4 exhibit characteristic peaks corresponding to a perovskite structure, confirming that they each have the same crystal structure.

It was confirmed that the crystal structure remained unchanged despite compositional variations in the solid ion conductors manufactured in Examples 1 to 4.

The solid ion conductors manufactured in Examples 1 to 4 were confirmed to have a perovskite structure that includes a cubic phase. No tetragonal phase was detected.

In the solid ion conductors having a perovskite structure of Examples 1 to 4, Ba, La, and/or Sr are positioned in the 12-coordination cuboctahedral site, and Co and Fe are positioned in the 6-coordination octahedral site. In the solid ion conductor having a perovskite structure of Example 4, Ba, Pr, La, Sr, and Ca are positioned in the 12-coordination cuboctahedral site, and Co, Fe, and Zn are positioned in the 6-coordination octahedral site.

### Evaluation Example 2: Impedance

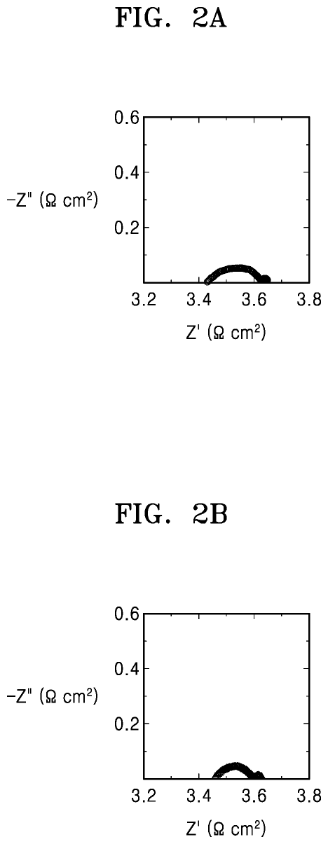

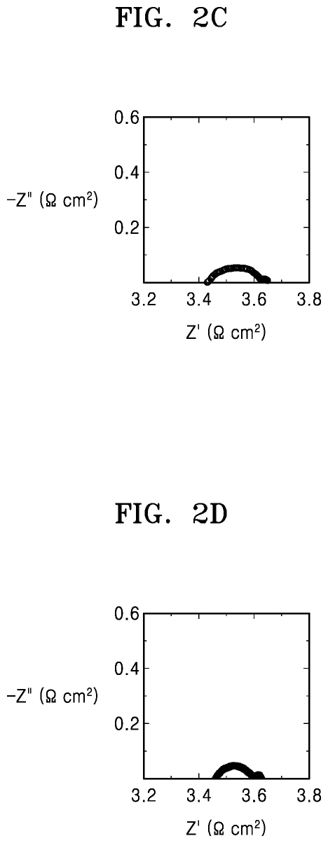

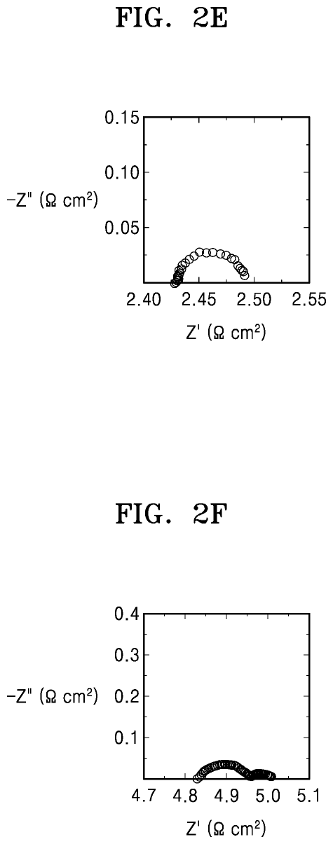

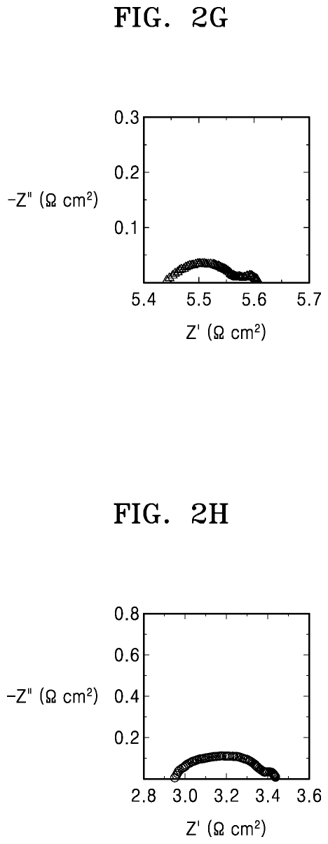

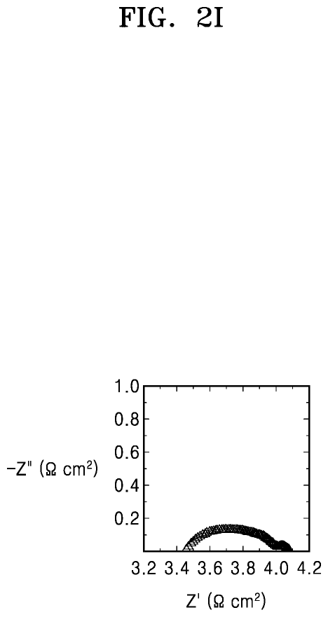

For the solid oxide cells manufactured in Examples 1, 2, and 5, Comparative Example 3, and Reference Example 1, impedance was measured both before and after applying a constant current at a current density of 1.0 A/cm² for 100 hours at 700 °C Impedance was measured using an impedance analyzer (Solartron 1400A/1455A) with a two-probe method. The frequency range was 0.1 Hz to 1 MHz, and the amplitude voltage was 10 mV. Nyquist plots for the impedance measurement results are shown in FIGS. 2A to 61.

FIGS. 2A and 2B are Nyquist plots showing the impedance measurement results of the solid oxide cell manufactured in Example 1 before and after applying constant current at a current density of 1.0 A/cm² for 100 hours at 700 °C

FIGS. 2C and 2D are Nyquist plots showing the impedance measurement results of the solid oxide cell manufactured in Example 2 before and after applying constant current at a current density of 1.0 A/cm² for 100 hours at 700 °C

FIG. 2E is a Nyquist plot showing the impedance measurement results of the solid oxide cell manufactured in Example 5 before applying constant current.

FIGS. 2F and 2G are Nyquist plots showing the impedance measurement results of the solid oxide cell manufactured in Comparative Example 3 before and after applying constant current.

FIGS. 2H and 2I are Nyquist plots showing the impedance measurement results of the solid oxide cell manufactured in Reference Example 1 before and after applying constant current.

As shown in FIGS. 2A, 2C, and 2E, the ohmic resistance (Rohm) before applying constant current in the symmetric cells including the solid ion conductors of Examples 1, 2, and 5 was reduced in comparison to the ohmic resistance (Rohm) before applying constant current in the symmetric cell including the solid ion conductors of Comparative Example 3 of FIG. 2F. From these results, it was confirmed that the air electrodes including the solid ion conductors of Examples 1, 2, and 5 had reduced contact resistance with the solid electrolyte layer and/or reaction barrier layer compared to the air electrodes including the solid ion conductor of Comparative Example 3, even before the operation of the solid oxide cells.

Additionally, an increase in the ohmic resistance (Rohm) before and after applying constant current in the symmetric cells including the solid ion conductors of Examples 1 and 2 was reduced compared to an increase in the ohmic resistance (Rohm) before and after applying constant current in the symmetric cell including the solid ion conductors of Comparative Example 3. From these results, it was confirmed that the air electrodes including the solid ion conductors of Examples 1 and 2 more effectively suppressed the formation of insulating phases during the operation of the solid oxide cells compared to the air electrodes including the solid ion conductor of Comparative Example 3.

Additionally, the polarization resistance (Rₚₒₗ) before and after applying constant current in the symmetric cells including the solid ion conductor of Example 1 showed almost no change and was approximately 0.6 Ω·cm², and the polarization resistance (Rₚₒₗ) before and after applying constant current in the symmetric cells including the solid ion conductor of Example 2 showed almost no change and was approximately 0.9 Ω·cm². It was also confirmed that the symmetric cells including the solid ion conductors of Examples 1 and 2 had reduced polarization resistance, i.e., an interfacial resistance, in comparison to the symmetric cells including the solid ion conductor of Comparative Example 3, thereby improving the reversibility of electrode reactions at the interface. Additionally, it was confirmed that the symmetric cells including the solid ion conductors of Examples 1 and 2 had reduced polarization resistance, i.e., an interfacial resistance, in comparison to the symmetric cells including the solid ion conductor of Reference Example 1, thereby improving the reversibility of electrode reactions at the interface.

The area-specific resistance (ASR) was calculated based on the polarization resistance (Rₚₒₗ) and air electrode area for the solid ion conductors of Examples 1, 2, and 5. The area specific resistance (ASR) was calculated from Equation 2 below. Since the symmetric cell includes two air electrodes, the air electrode area was divided by two.

Area specific resistance (ASR)=[polarization resistance (Rₚₒₗ)×air electrode area/2] Equation 2

The specific resistance of each of the air electrodes including the solid ion conductors of Examples 1, 2, and 5 was 0.5 Ω·cm² or less.

The air electrode including the solid ion conductor of Comparative Example 3 exhibits a higher area specific resistance than the air electrodes including the solid ion conductors of Examples 1, 2, and 5. It was confirmed that the solid ion conductors of Examples 1, 2, and 5 exhibited reduced interfacial resistance compared to conventional solid ion conductors. Polarization resistance, that is, interfacial resistance, corresponds to processes such as the migration of oxygen ions, oxygen exchange reactions, oxygen reduction reactions, and gas diffusion reactions in the air electrode.

### Evaluation Example 3: Durability Measurement

For the solid oxide cells manufactured in Examples 1, 2, 3, and 5, Comparative Example 3, and Reference Example 1, while a constant current was applied at a current density of 1.0 A/cm² at 700 °C for 100 hours and water vapor was supplied, the voltage change over time was measured to evaluate the durability of each solid oxide cell. While a constant current was applied in this way, an oxygen reduction reaction (ORR) and an oxygen evolution reaction (OER) each proceeded at a pair of air electrodes.

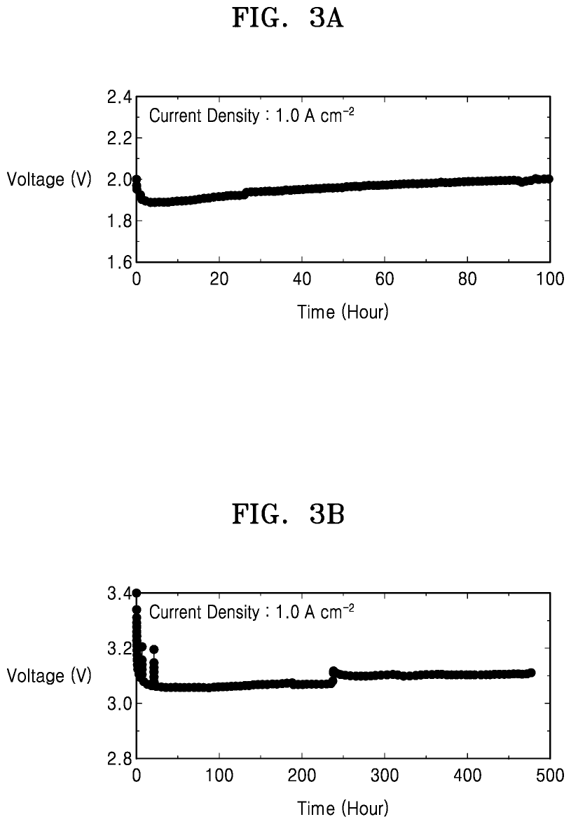

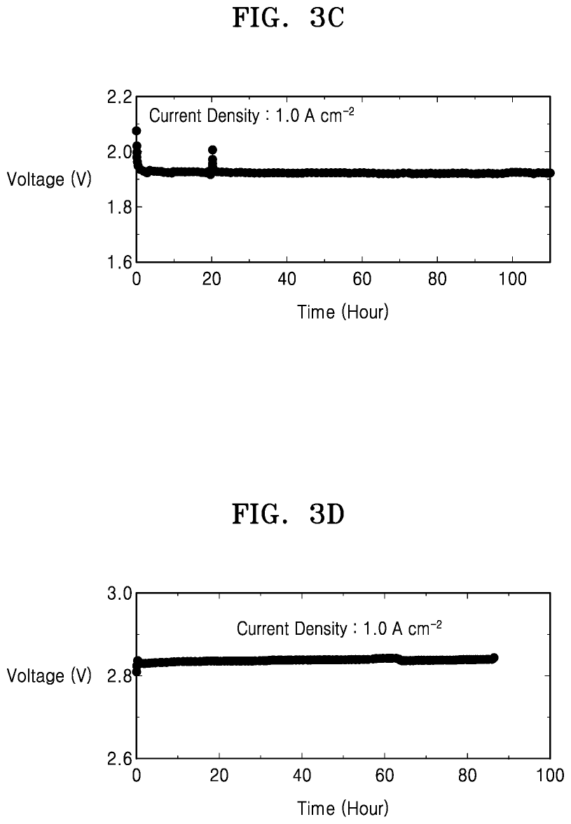

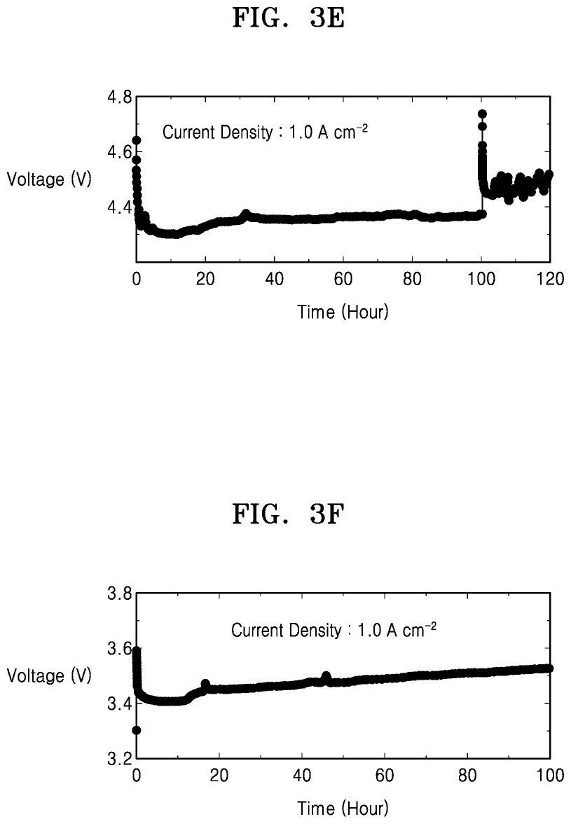

FIGS. 3A to 3F are graphs showing the durability evaluation results for solid oxide cells in the form of symmetrical cells including the solid ion conductors of Examples 1, 2, 3, and 5, Comparative Example 3, and Reference Example 1, respectively. While a constant current in this way, an oxygen reduction reaction (ORR) and an oxygen evolution reaction (OER) each proceeded at a pair of air electrodes.

As shown in FIGS. 3A to 3D, while the symmetrical cells including the solid ion conductors of Examples 1, 2, 3, and 5 were driven by applying a constant current at a current density of 1 A/cm² for 100 hours, the voltages of the symmetrical cells were stable without abrupt voltage changes.

In contrast, as shown in FIG. 3E, the voltage of the symmetric cell including the solid ion conductor of Comparative Example 3 changed rapidly when the application time of a constant current exceeded 100 hours. Further, as shown in FIG. 3E, it was found that the voltage of the symmetric cell increased as the application time of a constant current in the symmetric cell including the solid ion conductor of Reference Example 1 passed.

It was confirmed that the solid oxide cells including the solid ion conductors of Examples 1, 2, 3, and 5 had improved structural stability and life characteristics compared to the solid oxide cells including the solid ion conductor of Comparative Example 3 and the solid ion conductor of Reference Example 1.

### Evaluation Example 4: Activation Energy Evaluation

The activation energy of the solid ion conductors of Examples 6 and 7 and Comparative Example 2 was evaluated. The activation evaluation method is as follows.

Analysis was performed using electrochemical impedance spectroscopy (EIS). EIS analysis was performed at an amplitude of about 10 mV and a frequency of 0.1 Hz. The total resistance (Rₜₒₜₐₗ) value is obtained from impedance results, and conductivity values are calculated by correcting an electrode area and a pellet thickness from this value. In addition, during EIS measurement, activation energy (Ea) values for Li ion conduction were calculated from the measurement results obtained by changing a chamber temperature into which each solid conductor sample was loaded. From the conductivity values measured at different temperatures in the range of 298 to 378 K, Ea may be calculated from a slope value by converting these values to the Arrhenius plot (Ln (CT) vs. 1/T) of Equation 3 below.

σT=A exp(Ea/RT) Equation 3

in Equation 3, Ea represents activation energy, T represents an absolute temperature, A represents a pre-exponential factor, σ represents conductivity, and R represents a gas constant.

The evaluation results of the activation energy evaluation are shown in Table 2 below, and solid oxide cells were manufactured using the solid ion conductors of Examples 6 and 7 and Comparative Example 2 in the same method as in Example 1.

Activation energy was calculated using quantum calculations. Quantum calculations were performed using density functional theory (DFT).

TABLE 2

| Class. | Composition | Ea(eV) |
|---|---|---|
| Example 6 | Pr_{0.2}Ba_{0.2}La_{0.2}Sr_{0.2}Ca_{0.2}Co_{0.8}Fe_{0.2}O_{2.56} | 0.4 |
| Example 7 | Pr_{0.2}Ba_{0.2}La_{0.2}Sr_{0.2}Ca_{0.2}Co_{0.6}Fe_{0.4}O_{2.59} | 0.32 |
| Comparative | Pr_{0.2}Ba_{0.2}La_{0.2}Sr_{0.2}Ca_{0.2}Co_{0.2}Fe_{0.8}O_{2.63} | 0.81 |
| Example 2 | | |

As shown in Table 2, the solid ion conductors of Examples 6 and 7 showed a reduced activation energy of 0.5 eV or less compared to the solid ion conductor of Comparative Example 2. The electrodes and solid oxide cells including the solid ion conductors of Examples 6 and 7 having the above-described activation energy values can exhibit high OER catalytic activity and high oxygen-ion conductivity.

According to one aspect, there is provided a novel solid ion conductor having improved structural stability due to a high-entropy effect is provided. Since such a solid ion conductor has excellent catalytic characteristics for oxygen evolution reaction (OER) and oxygen reduction reaction (ORR), and it has low area specific resistance (ASR) characteristics. Further, since this solid ion conductor does not cause cation segregation on the surface thereof, the solid ion conductor can be used to manufacture solid oxide cells having improved durability.

Although the present disclosure has been described through embodiments, the disclosure is not limited thereto, and it is possible to implement the disclosure by making various modifications within the scope of the patent claims, the detailed description of the disclosure, and the attached drawings, and it is obvious that this also belongs to the scope of the disclosure.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A solid ion conductor comprising a metal oxide having a perovskite structure,
wherein the metal oxide includes: four or more different elements arranged in a cubooctahedral site of the perovskite structure, where the four or more different elements include i) barium, strontium, and M¹ and M² elements, or ii) barium, strontium, and M¹, M² and M³ elements; and
cobalt and iron, or ii) cobalt, iron, and M⁴, arranged in the octahedral site of the perovskite structure,
wherein
M¹ and M² are each independently a cation having an oxidation number of 3+, a lanthanide element, a group 3 element, a group 5 element, a group 8 element, a group 10 element, or a combination thereof,
M³ is a cation having an oxidation number 2+ or 3+, a group 2 element, a group 5 element, or a combination thereof, and
M⁴ is a transition metal having an oxidation number 2+ or 3+, a group 4 element, a group 7 element, a group 10 to 13 element, a group 16 element, or a combination thereof, and
molar content of elements barium, strontium, M¹ and M² are each 0.5 or less with respect to a total moles of the elements barium, strontium, M¹ and M²; or molar content of elements barium, strontium, M¹, M² and M³ are each 0.5 or less with respect to a total of the elements barium, strontium, M¹, M² and M³, and
a molar content of cobalt is equal to or greater than a molar content of iron.

2. The solid ion conductor of claim 1, wherein the metal oxide having a perovskite structure is represented by Formula 1:
(BaₐSr_{b}M¹_{c}M²_{d}M³ₑ)(Co_{f}Fe_{g}M⁴ₕ)O_{3-δ} Formula 1
wherein
0.1≤a≤0.4, 0.1≤b≤0.4, 0.1≤c≤0.5, 0.1≤d≤0.4, 0≤e≤0.4, f>0, g>0, f>g, 0≤h<0.2, 0≤δ<1, 0.9≤(a+b+c+d+e)≤1, and 0.9≤(f+g+h)≤1.

3. The solid ion conductor of claim 2, wherein, in Formula 1, 0.4≤f≤0.9, 0.1≤g≤0.6, and 1.1≤f/g≤5.0.

4. The solid ion conductor of claim 1, wherein, in Formula 1, ion radii of M¹ and M² are smaller than ion radii of barium and strontium.

5. The solid ion conductor of claim 1, wherein M¹ and M² are each independently lanthanum, praseodymium, yttrium, scandium, samarium, gadolinium, or a combination thereof.

6. The solid ion conductor of claim 1, wherein M³ is calcium, magnesium, radium, lanthanum, praseodymium, yttrium, or a combination thereof.

7. The solid ion conductor of claim 1, wherein M⁴ is zinc, manganese, ytterbium, nickel, copper, titanium, holmium, or a combination thereof.

8. The solid ion conductor of claim 1, wherein the molar content of barium, strontium, M1 and M2 are each essentially the same, or barium, the molar content of strontium, M1, M2 and M3 are each essentially the same.

9. The solid ion conductor of claim 1, wherein the metal oxide is represented by Formula 2:
(Baₐ₁Sr_{b1}Pr_{c1}La_{d1}M³ₑ₁)(Co_{f1}Fe_{g1}M⁴ₙ₁)O_{3-δ} Formula 2
wherein, in Formula 2,
M³ is a cation having an oxidation number of 3+, a group 2 element, a group 5 element, or a combination thereof, and
0.1≤a1≤0.4, 0.1≤b1≤0.4, 0.1≤c1≤0.5, 0.1≤d1≤0.4, 0≤e1≤0.4, f1> g1, 0.4≤f1≤0.9, 0.1≤g1≤0.6, 0≤h1<0.2, 0≤δ<1, 0.9≤(a1+b1+c1+d1+e1)≤1, and 0.95≤(f1+g1+h1)≤1, and δ is an oxygen defect.

10. The solid ion conductor of claim 9, wherein M³ is calcium, strontium, barium, radium, lanthanum, praseodymium, yttrium, or a combination thereof, and M⁴ is calcium, magnesium, radium, or a combination thereof.

11. The solid ion conductor of claim 1, wherein the metal oxide is at least one compound represented by Formulae 3 to 6:
(Baₐ₂Sr_{b2}Pr_{c2}La_{d2})(Co_{f2}Fe_{g2})O_{3-δ} Formula 3
wherein, in Formula 3,
0.01≤a2≤0.5, 0.01≤b2≤0.5, 0.01≤c2≤0.5, 0.1≤d2≤0.9, 0.1≤e2≤0.4, f2>g2, 0.4≤f2≤0.9, 0.1≤g2≤0.6, 0≤δ<1, 0.9≤(a2+b2+c2+d2+e2)≤1, and 0.95≤(f2+g2+h2)≤1, and δ is an oxygen defect,
(Baₐ₂Sr_{b2}Pr_{c2}La_{d2}Caₑ₂)(Co_{f2}Fe_{g2})O_{3-δ} Formula 4
wherein, in Formula 4,
0.01≤a2≤0.5, 0.01≤b2≤0.5, 0.01≤c2≤0.5, 0.1≤d2≤0.9, 0.1≤e2≤0.4, f2>g2, 0.4≤f2≤0.9, 0.1≤g2≤0.6, 0≤δ0<1, 0.9≤(a2+b2+c2+d2+e2)≤1, and 0.95≤(f2+g2+h2)≤1, and δ is an oxygen defect,
(Baₐ₂Sr_{b2}Pr_{c2}La_{d2}Yₑ₂)(Co_{f2}Fe_{g2})O_{3-δ} Formula 5
wherein, in Formula 5,
0.01≤a2≤0.5, 0.01≤b2≤0.5, 0.01≤c2≤0.5, 0.1≤d2≤0.9, 0.1≤e2≤0.4, f2>g2, 0.4≤f2≤0.9, 0.1≤g2≤0.6, 0≤δ0<1, 0.9≤(a2+b2+c2+d2+e2)≤1, and 0.95≤(f2+g2+h2)≤1, and δ is an oxygen defect,
(Baₐ₂Sr_{b2}Pr_{c2}La_{d2}Caₑ₂)(CO_{f2}Fe_{g2}Znₕ₂)O_{3-δ} Formula 6
wherein, in Formula 6,
0.01≤a2≤0.5, 0.01≤b2≤0.5, 0.01≤c2≤0.5, 0.1≤d2≤0.9, 0.1≤e2≤0.4, f2>g2, 0.4≤f2≤0.9, 0.1≤g2≤0.6, 0≤h2<0.2, 0≤δ<1, 0.9≤(a2+b2+c2+d2+e2)≤1, and 0.95≤(f2+g2+h2)≤1, and δ is an oxygen defect.

12. The solid ion conductor of claim 1, wherein the solid ion conductor exhibits at least two of the following properties:
an area specific resistance (ASR) of 0.5 Ω/cm² or less at 700 °C, as measured by an AC impedance method,
a thermal expansion coefficient (TEC) of 20×10⁻⁶/K or less,
an activation energy of 0.5 eV or less, or
a configurational entropy that exceeds 1.5R.

13. The solid ion conductor of claim 1, further comprising an ion-conductive metal oxide distinct from the metal oxide having a perovskite structure, in a form of a composite with the metal oxide having a perovskite structure.

14. A solid oxide cell comprising: an air electrode; a fuel electrode; and a solid electrolyte layer between the air electrode and the fuel electrode,
wherein at least one of the air electrode, the fuel electrode, and the solid electrolyte layer includes a solid ion conductor,
the solid ion conductor includes a metal oxide having a perovskite structure,
the metal oxide includes: four or more different elements arranged in a cubooctahedral site of the perovskite structure, where the four or more different elements include i) barium, strontium, and M¹ and M² elements, or ii) barium, strontium, and M¹, M² and M³ elements; and
cobalt and iron, or ii) cobalt, iron, and M⁴, arranged in the cubooctahedral site of the perovskite structure,
M¹ and M² are each independently a cation having an oxidation number of 3+, a lanthanide element, a group 3 element, a group 5 element, a group 8 element, a group 10 element, or a combination thereof,
M³ is a cation having an oxidation number 2+ or 3+, a group 2 element, a group 5 element, or a combination thereof, and
M⁴ is a transition metal having an oxidation number 2+ or 3+, a group 4 element, a group 7 element, a group 10 to 13 element, a group 16 element, or a combination thereof, and
molar contents of elements barium, strontium, M¹ and M² are each 0.5 or less with respect to a total moles of the elements barium, strontium, M¹ and M²; or molar contents of elements barium, strontium, M¹, M² and M³ are each 0.5 or less with respect to a total moles of the elements barium, strontium, M¹, M² and M³, and
a molar content of cobalt is equal to or greater than a molar content of iron.

15. The solid oxide cell of claim 14, wherein the metal oxide having a perovskite structure is represented by Formula 1:
(BaₐSr_{b}M¹_{c}M²_{d}M³ₑ)(Co_{f}Fe_{g}M⁴ₕ)O_{3-δ} Formula 1
wherein
0.1≤a≤0.4, 0.1≤b≤0.4, 0.1≤c≤0.5, 0.1≤d≤0.4, 0≤e≤0.4, f>0, g>0, f>g, 0≤h<0.2, 0≤δ<1, 0.9≤(a+b+c+d+e)≤1, and 0.9≤(f+g+h)≤1.

16. The solid oxide cell of claim 14, wherein the solid oxide cell is a solid oxide fuel cell or a solid oxide electrolyzer cell.

17. A method of manufacturing a solid ion conductor, the method comprising:
mixing a barium precursor, a strontium precursor, an M¹ precursor, an M² precursor, a cobalt precursor, an iron precursor, and optionally, an M³ precursor and/or an M⁴ precursor, to prepare a precursor mixture; and
heat-treating the precursor mixture to prepare the solid ion conductor
wherein the solid ion conductor includes a metal oxide having a perovskite structure,
the metal oxide includes four or more elements arranged in a cubooctahedral site of the perovskite structure, where the four or more different elements include i) barium, strontium, and M¹ and M² elements or ii) barium, strontium, and M¹, M² and M³ elements; and
cobalt and iron, or ii) cobalt (Co), iron (Fe), and M4, arranged in the octahedral site of the perovskite structure,
wherein
M¹ and M² are each independently a cation having an oxidation number of 3+, a lanthanide element, a group 3 element, a group 5 element, a group 8 element, a group 10 element, or a combination thereof,
M³ is a cation having an oxidation number 2+ or 3+, a group 2 element, a group 5 element, or a combination thereof, and
M⁴ is a transition metal having an oxidation number 2+ or 3+, a group 4 element, a group 7 element, a group 10 to 13 element, a group 16 element, or a combination thereof, and
molar content of elements barium, strontium, M¹ and M² are each 0.5 or less with respect to a total of the elements barium, strontium, M¹ and M²; or molar content of elements barium, strontium, M¹, M² and M³ are each 0.5 or less with respect to a total of the elements barium, strontium, M¹, M² and M³, and
a molar content of cobalt is equal to or greater than a molar content of iron.

18. The method of claim 17,
wherein the metal oxide having a perovskite structure is represented by Formula 1:
(BaₐSr_{b}M¹_{c}M²_{d}M³ₑ)(Co_{f}Fe_{g}M⁴ₕ)O_{3-δ} Formula 1
wherein
0.1≤a≤0.4, 0.1≤b≤0.4, 0.1≤c≤0.5, 0.1≤d≤0.4, 0≤e≤0.4, f>0, g>0, f>g, 0≤h<0.2, 0≤δ<1, 0.9 (≤a+b+c+d+e)≤1, and 0.9≤(f+g+h)≤1.

19. The method of claim 17, wherein the M3 precursor and/or the M4 precursor is added to the precursor mixture.

20. The method of claim 17, further comprising mixing a complexing agent and deionized water to the precursor mixture to prepare a precursor composition,
and the heat-treating the precursor mixture includes a first heat-treating of the precursor composition at a first temperature to prepare a gelled powder; and a second heat-treating at a second temperature of the gelled powder.
